(19) United States
(12) Patent Application Publication
(10) Pub. No.: US 2023/0289835 A1
(43) Pub. Date: Sep. 14, 2023

(54) MULTI-CHANNEL DEMAND PLANNING FOR INVENTORY PLANNING AND CONTROL

(71) Applicant: Target Brands, Inc., Minneapolis, MN (US)

(72) Inventors: DUANE SIZEMORE, Minneapolis, MN (US); GREGORY THOMAS CASE, Woodbury, MN (US); JACOB MICHAEL MELVIN LUBY, Plymouth, MN (US); DANNY BROOK TANNER, Bloomington, MN (US)

(73) Assignee: Target Brands, Inc., Minneapolis, MN (US)

(21) Appl. No.: 18/319,902

(22) Filed: May 18, 2023

Related U.S. Application Data
(63) Continuation-in-part of application No. 17/529,075, filed on Nov. 17, 2021.

(51) Int. Cl. G06Q 30/0202; G06Q 10/087

(52) U.S. Cl. CPC G06Q 30/0202; G06Q 10/087

(57) ABSTRACT

Methods and systems for forecasting demand for items across multiple channels are disclosed. In some implementations, multi-channel demand forecasting may be performed on a per-item, per-location basis, by selectively generating item-location forecasts for each item and location within a supply chain for each channel, or disaggregating a chain level forecast on a per-item basis to each location. Particular selection of an appropriate model, and selective training of models, allows for efficient computation of such forecasts across a large supply chain with thousands of locations and hundreds of thousands, or millions, of items for which forecasts are generated.

### CROSS-REFERENCE TO RELATED APPLICATIONS

The present Application claims priority as a continuation-in-part application from U.S. patent application Ser. No. 17/529,075, filed on Nov. 17, 2021, the disclosure of which is hereby incorporated by reference in its entirety.

### TECHNICAL FIELD

The present disclosure relates generally to methods and systems for forecasting demand for items across multiple channels.

### BACKGROUND

Demand forecasting involves predicting future demand for products or services of a business or organization. Demand forecasting produces valuable information for businesses to use in production planning, inventory management, staff scheduling, and supply chain management. It is important to know how much inventory is needed to order and stock at various locations of a retail chain. Demand forecasting information can be useful not only for inventory management, but for scheduling personnel, planning marketing events, and budgetary planning.

At its most basic, forecasting demand may involve simply estimating demand using judgment based on past experience, which may be effective for smaller businesses or more predictable businesses. In more complex situations, demand can be calculated using a variety of statistical models and algorithms. Such models and algorithms typically rely on past data to predict future demand.

It can be difficult to accurately predict future demand for products, especially when taking into account seasonal changes in demand for particular products. This is further complicated for retailers offering a multitude of products, e.g. millions. There is a need for improved methods of forecasting demand for a large number of products taking into account seasonal changes in demand.

For large retail organizations, particularly those which are distributed over a large geographical area, it is not uncommon for different retail locations to carry different collections of items for sale. As such, demand predictions for any given location within a retail enterprise may be localized to a particular retail location, especially for physical, in-store item sales. Also in some instances, large retail organizations may also fulfill digital orders (e.g., orders received via a website) from either warehouses, or in some instances, from stores (as examples of retail locations). This drastically complicates the way in which demand may be attributed to a particular location. For example, while total demand for an item from a particular retail location may be driven by both in-store sales and online order fulfillment, any online orders fulfilled from a given location may not be properly attributed to that location. This may be because the decision to fulfill a digital order from a particular retail location may be based on a customer request to pick up the item at that particular retail location, or may be based on a decision of the retailer to fulfill an online order from that location by shipping the item to the customer. In the first case, item demand may be properly attributable to the retail location, but in the second case, the particular retail location is not a factor in the customer's purchasing decision, so attributing demand to that location is somewhat arbitrary, and may in fact be incorrect. It may also be the case that digital demand may be attributed to a particular store or warehouse location simply because that store or warehouse has the item in stock at the time an order is received, rather than the location being the most appropriate location from which item fulfillment should occur. In this case as well, attributing demand on a location-specific basis is likely inaccurate.

### SUMMARY

In summary, the present disclosure relates to methods and systems for forecasting demand for items across multiple channels. In some implementations, multi-channel demand forecasting may be performed on a per-item, per-location basis, by selectively generating item-location forecasts for each item and location within a supply chain for each channel, or disaggregating a chain level forecast on a per-item basis to each location. Particular selection of an appropriate model, and selective training of models, allows for efficient computation of such forecasts across a large supply chain with thousands of locations and hundreds of thousands, or millions, of items for which forecasts are generated.

In a first aspect, a system for forecasting demand of an item is disclosed. The system includes at least one processor and at least one memory device, the memory device storing instructions that, when executed by the at least one processor, cause the system to: receive a model-based demand forecast for an item from a demand forecasting system; display a user interface, the user interface comprising a demand forecast display including the model-based demand forecast for the item; display one or more input fields for overriding the model-based demand forecast; receive, via the one or more input fields for overriding the model-based demand forecast, a user override demand forecast including the item and one or more override values for one or more time periods; and display, in the demand forecast display, the one or more override values for the one or more time periods.

In a second aspect, a method for forecasting demand of an item is disclosed. The method includes receiving a model-based demand forecast for an item from a demand forecasting system; displaying a user interface, the user interface comprising a demand forecast display including the model-based demand forecast for the item; displaying one or more input fields for overriding the model-based demand forecast; receiving, via the one or more input fields for overriding the model-based demand forecast, a user override demand forecast including the item and one or more override values for one or more time periods; and displaying, in the demand forecast display, the one or more override values for the one or more time periods.

In a third aspect, a non-transitory computer-readable medium is disclosed. The non-transitory computer-readable medium has stored instructions thereon, which when executed by a processor, cause the processor to forecast demand by performing a method comprising: receiving a model-based demand forecast for an item at a location from a demand forecasting system; generating a user interface, the user interface comprising a demand forecast display including the model-based demand forecast for the item; generating, for display in the user interface, one or more input fields for overriding the model-based demand forecast; receiving, via the one or more input fields for overriding the model-based demand forecast, a user override demand forecast including the item and one or more override values at the location for one or more time periods; and generating, for display in the demand forecast display, the one or more override values for the one or more time periods.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic diagram of an example portion of a retail supply chain within which aspects of the present disclosure may be implemented.

FIG. 2 illustrates an example block diagram of an example computing environment in which a multi-channel demand planning system may be used, for example within a retail organization.

FIG. 3 illustrates a logical diagram of a breakdown of demand forecasts and relationship to item positioning.

FIG. 4 is a flow chart of an example method of using chain level and localized demand forecasting models to generate localized, multi-channel demand forecasts.

FIG. 5 shows a more detailed schematic diagram of an example method of managing and attributing digital demand forecasts to individualized locations, for example by disaggregation of chain level forecasts.

FIG. 6 is an architecture diagram of a multi-channel demand planning system within which aspects of the present disclosure may be implemented.

FIG. 7 is a logical flow diagram illustrating selection among a plurality of different demand forecast models within the multi-channel demand planning system described herein.

FIG. 8 is a logical flow diagram illustrating example methods of performance optimization of individual demand forecasting models, in example embodiments.

FIG. 9 illustrates an example computing system with which aspects of the present disclosure may be implemented.

FIG. 10 illustrates an example network environment in which aspects of the present disclosure may be implemented.

FIG. 11 is a logical flow diagram for forecasting demand.

FIG. 12 illustrates an example user interface having a display including demand forecasts.

FIG. 13 illustrates an example user interface having a display including demand forecasts.

FIG. 14 illustrates an example user interface having a display including demand forecasts.

FIG. 15 illustrates an example user interface having a display including demand forecasts.

FIG. 16 illustrates an example user interface including a plurality of components for forecasting demand.

FIG. 17 illustrates an example user interface for receiving a user override demand forecast.

FIG. 18 illustrates an example user interface for receiving a user override demand forecast.

FIG. 19 illustrates example data corresponding to a user override demand forecast.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In general, the present disclosure relates to methods and systems for forecasting demand for a plurality of items. In particular, the demand forecasting system and methods described herein are useful for predicting demand of products in a retail context. In particular examples, the methods and systems described herein are particularly advantageous in forecasting separate demand components for in-store sales as well as sales via digital systems, which may or may not be localized to a particular store by the customer. By separately determining forecast demand components, future forecast may be better attributed to locations within a retail supply chain (e.g. “nodes”, including warehouses and stores).

In example aspects, an enterprise wide digital originated demand may be generated, and disaggregated on a per item basis to individual locations. In other examples, a more optimized, localized digital demand forecasts may be generated. An overall demand forecasting architecture allows for selection between disaggregated digital demand and localized digital demand forecasting. Model management processes are also described which manage retraining of forecasting models in a manner that is sensitive to the updates in item demand or availability of historical item demand, and which may reduce computational complexity of generating per-item, per-location, and per-channel forecasts across a large-scale retail supply chain.

In example aspects, the systems and methods disclosed herein may include features to facilitate the management of inventory. For instance, in some embodiments, forecasted demand and other data may be displayed via a user interface that may be part of an inventory management system. Furthermore, in some instances, a user may input a user override demand forecast via the user interface. The user override demand forecast may replace the forecasted demand, thereby allowing the user (e.g., an inventory manager) to decide when to allow one or more models to predict demand and when to use information that may not be captured by the models to manually predict demand. As a result, the systems and methods may provide more accurate forecasts and be implemented for situations in which models may not accurately forecast demand.

The systems and methods described herein are generally more applicable to retailers offering thousands or millions of different items for sale. These items are sold at hundreds of retail stores and there are also hundreds of distribution centers. It is very difficult to manage demand for such a wide variety of items at so many locations. Some items are in demand everywhere on a daily basis, while others only sell occasionally and may only be in demand in certain locations. Thus, the information needed to determine how to position inventory to meet demand needs to be accurate. Due to the large number of items and locations, the process of analyzing that information has to be efficient in order to effectively utilize the information for demand planning purposes.

The systems and methods described herein have a number of advantages in the context of such a large scale supply chain, an example of which is described below. In particular, placement of appropriate volumes and selections of items at the various locations within the supply chain allow for improved responsiveness to customer ordering behavior. Customers are increasingly expecting relatively short delivery time frames for all types of items (e.g., within 1 to 2 days). By better attributing demand, and forecasting demand, at individual locations for individual items within a large-scale supply chain, item placement planning may be improved, which improves responsiveness and efficiency of the overall supply chain.

As may be expected in such a system, the number of different types of forecasting models (e.g., on a per channel, per location, per item basis) can require significant computational resources. As described herein, such computational challenges may be addressed by managing the extent to which models are created, trained, and scored based on the attributes of particular locations or items that are forecasted.

As further discussed below, in some example aspects, the systems and methods described herein may provide various user interfaces for display of demand forecasts. In such examples, user-facing tools may be provided to conveniently override a generated demand forecast for one or more future periods of time (e.g., on a weekly basis, or other time-based granularity). Such user interface tools may allow for selectively overriding a demand forecast at a selected location or locations within an enterprise supply chain, for a selected one or more items. The demand forecasting system may also override demand forecasts on a per-channel basis, or at some other granularity subdivision, and may distribute, or disaggregate, chain-wide or item-group-wide user overrides across locations, items, etc. as needed to generate individual location-item-period forecasts as needed. Such user interface tools improve flexibility of such tools, and therefore improve the user experience in working with overall enterprise demand forecasting tools.

### I. Example Large Scale Retail Enterprise Supply Chain Architecture with Flexible Delivery Models

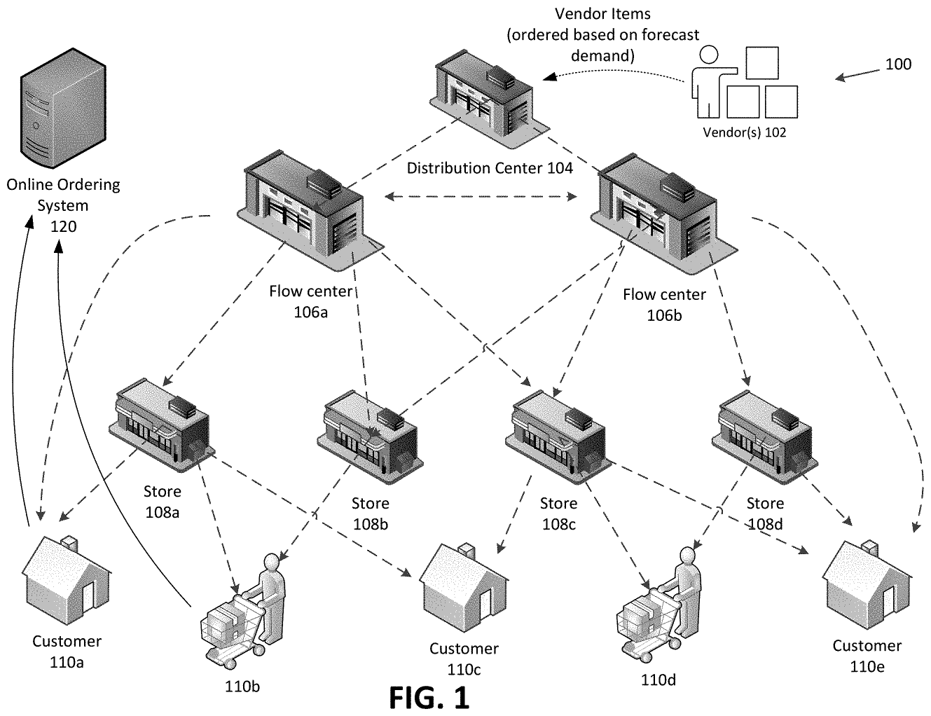

FIG. 1 illustrates a schematic diagram 100 of an example supply chain for a retail enterprise, in which aspects of the present disclosure may be implemented. The diagram 100 illustrates the flow of inventory from vendor 102 to customer 110. The inventory moves through various nodes to arrive at the customer. In this example, the nodes include a distribution center 104, two flow centers 106a, 106b, four retail stores 108a, 108b, 108c, 108d, and ultimately to various customers, such as to customers 110b, 110d who obtain items via in-store shopping and/or order pickup from a particular store, as well as three customer residences 110a, 110c, 110e, which may receive goods in response to online orders. In practice, the supply chain could include many more nodes in different proportions. In some embodiments, there are not separate receive centers and flow centers. Instead, there may be one type of warehouse or distribution center for holding inventory before distributing to stores and customers. Dashed-line arrows in the diagram indicate movement of inventory. Inventory will typically flow downward through the supply chain, but in some instances inventory may move between flow centers 106 or between retail stores 108. In some embodiments, inventory may even move from a flow center 106 to a distribution center 104 or from a retail store 108 to a flow center 106.

In the example shown, in some instances items may be either shipped from a store to a customer, or may be picked up by a customer, in response to an online order. Online orders may be submitted to an online ordering system 120, depicted in solid line arrows from customer 110a, 110b.

It is further recognized that online orders will typically be submitted for fulfillment of orders delivered directly to customers, such as customer 110c, 110e. Generally speaking, each store 108 will fulfill orders in response to in-store shopping, online orders indicating a desire to pick up from a particular store, as well as online orders for which a shipment to a customer 110 is requested. For orders fulfilled in response in-store shopping or online orders indicating a desire to pick up from a particular store, such orders are considered “localized” in that a customer indicates a desire to purchase from a particular location. Online orders for which a shipment to a customer is requested may be assigned to a particular store 108 or flow center 106, but are assignable to any such store or flow center from which stock may be provided. That is, in some instances in order may be delivered from a closest store to the ZIP Code of the ordering customer, but in other instances, due to other anticipated demand for the particular item from that store or in response to excess stock at another store or flow center, it may be desirable to fulfill the online order for shipment to the customer from another location.

Vendors 102 produce/provide the items or products that will be sold by the retail entity. A purchase order is typically placed to request products from a vendor. In some instances, the vendor 102 will transport the ordered products to a distribution center 104. In other instances, the retail entity arranges for the products to be picked up from the vendor 102 and transported to the distribution center 104. Once at the distribution center 104, the products are prepared for transportation to one or more flow centers. The products may arrive from the vendors in large groupings that need to be broken down into individual units for distribution to flow centers 106 and/or stores 108. Accordingly, once received into the supply chain of the enterprise, each individual unit can be tracked and shipped among the various nodes of the supply chain (distribution centers 104, flow centers 106, and stores 108).

A variety of products are prepared for shipment to one or more flow centers 106. The flow centers 106 are typically positioned to enable quick shipment to one or more retail stores 108. Each flow center 106 may supply inventory to multiple retail stores 108. In some instances, more than one flow center 106 will send inventory to a retail store 108. For example, in FIG. 1, flow center 106a distributes inventory to stores 108a, 108b, and 108c. Flow center 106b distributes to stores 108b, 108c, and 108d. In some instances, to the extent products received at a flow center 106 are not already broken down into individual units, the products may be broken down into individual units in order to distribute individual items to stores 108, or optionally to fill online orders that will be delivered directly to customers from the flow center 106 or store 108. In the example of FIG. 1, products are shipped directly from flow center 106a to a customer 110a and from flow center 106b to customer 110c.

Once products arrive at the retail stores 108, they are either stored in a back room or displayed on shelves. This inventory is available for in-store purchases, pick-up orders, or local delivery. Depending on the location of a customer ordering products online, the shipments of products could come from one or more retail stores 108, or flow centers 106. For instance, customer 110b could receive shipments of products from either store 108b or store 108c, or both (in the instance of a multi-item purchase). In example implementations, individual stores 108 may stock only a subset of the collections of items available at either a flow center 106 or a distribution center 104. Still further, different flow centers 106 may stock different types of items, for example due to handling constraints. Still further, it is noted that, between receive centers 108, flow centers 106, and stores 108, there may be preexisting, predetermined delivery routes established. For example, there may be daily or weekly transit routes between a receive center and one or more flow centers. The distribution center can provide to the flow centers the selection of individual items that are needed by stores 108 serviced by the one or more flow centers proximate to and/or servicing those stores. The flow centers can also have daily or other periodic transportation routes established to stores that are serviced, thereby ensuring prompt replenishment of items at stores in response to item sales.

In addition, the predetermined delivery routes can be used for various purposes. For example, in some situations, the predetermined delivery routes can be used to deliver products in various forms. As explained in further detail below, items distributed via the supply chain are tracked on an individual (per-item) basis; as such, items can be delivered to stores 108 in any convenient manner. In some example embodiments, items are tracked on an individual basis, but may be grouped at a flow center 106 to simplify restocking of the store 108, for example by placing together in a package a collection of individual items of different types but which may easily be stocked conveniently once those items arrive at a store 108. For example, goods that are located in a common department, row, or shelf of a store can be grouped and packed together at the flow center 106. Once those items reach the store 108, a restocking operation can restock each of the items in that shelf, row, or department easily. Still further, because items are packed and tracked on an individual basis at the flow center and sent to stores based, at least in part, on demand signals received from stores, the item collections are based on the number of items sold and therefore the restocking operation can provide a package of items that will fit on store shelves, rather than requiring additional backroom stocking and storage.

In the context of the present disclosure, a supply chain management system is provided that assists in coordination of product shipments among nodes of the supply chain, and uses inventory models to automatically rebalance inventory within the supply chain of the enterprise to ensure predicted and actual item demand from customers of the enterprise is fulfilled to a predetermined threshold success rate. The supply chain management system allows for balancing of items across the supply chain based on inventory and demand models, as well as real time demand signals, and performs automated generation of purchase and transfer orders throughout the supply chain based on such demand and lead time calculations between paints both within and external to the supply chain. Accordingly, as noted below, substantial advantages are realized using the methods and systems of the present disclosure.

It is in this general supply chain retail environment that the following systems and methods operate. While the methods and systems are described in a retail environment having brick-and-mortar stores as well as online sales, additional applications are possible. For example, the systems and methods could operate in a supply chain of warehouses that only distribute products to customers in fulfillment of online orders. In other embodiments, the systems and methods could operate for distribution channels that distribute supplies to multiple locations within a business rather than selling to individual customers. Regardless of the application, the systems and methods described herein are most beneficial when used to manage a supply chain for a plurality of nodes with the goal of increasing efficiency of inventory movement by responding to both proactive and reactive demand signals in real time.

### II. Channel-Specific Demand Forecasting for Enterprise Supply Chain with Flexible Delivery Models

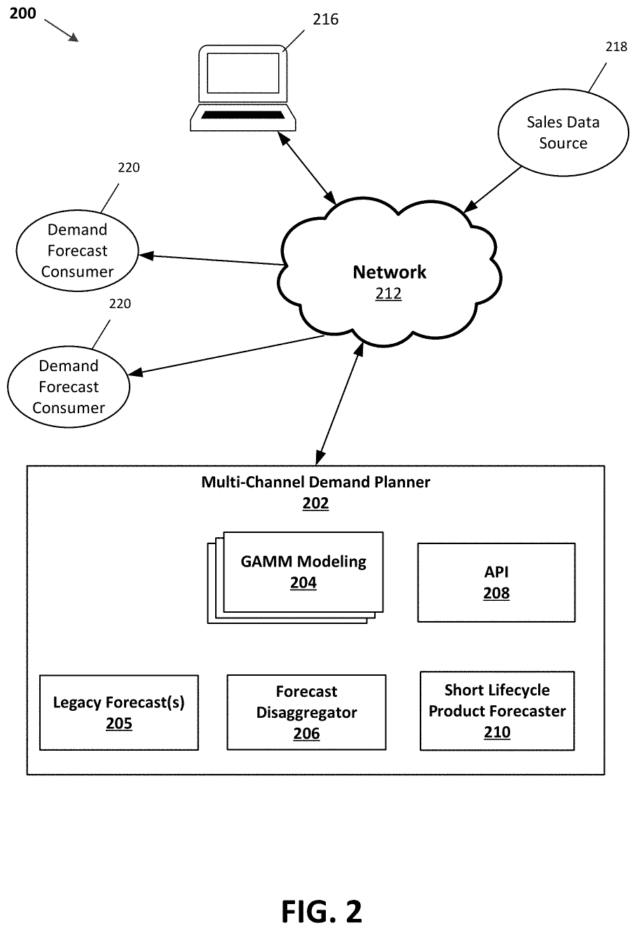

FIG. 2 illustrates a schematic diagram of a system 200 for planning item demand in multiple sales channels. In the example of FIG. 2, this system 200 includes a multi-channel demand planner 202 comprising one or more generalized additive models (GAM) 204, an application programming interface 208, a forecast disaggregator 206, and a short life cycle product forecaster 210. The multi-channel demand planner 202 operates to predict demand for items both at particular locations and in general geographic areas. The multiple sales channels can include online sales and in store sales. The online sales can be attributed to particular locations such as retail stores or can be attributed generally to any location that can ship the item to a customer within an allotted amount of time. The multi-channel demand planner communicates through a network 212 with one or more computing devices 216, at least one sales data source 218, and at least one demand forecast consumer 220.

In the example shown, the GAMs 204 correspond to models configured to predict demand for a given item based on sales data received from one or more sales data sources 218. In some embodiments, the GAM 204 is a generalized additive mixed model. In example embodiments, the GAMs 204 may include a separate chain level model and individual location models. As described further below, selection of an appropriate model may include selection of one or both of the chain level and the individual location models to improve forecast accuracy. In particular, where location models may lack sufficient data or otherwise may lack context (e.g., by attributing all in person and online sales demand as attributable to that location, as compared to considering particular reasons why prior sales were assigned to the location), chain level forecasts may be used to validate local demand.

In the example shown, a legacy forecast system 205 may also be included within the multi-channel demand planner 202. The legacy forecast system 205 may, in some instances, provide chain level and location level forecasts, but may not provide channel specific forecasts for either the chain level or location level. That is, a legacy forecast system may be configured to determine or forecast demand at each of a plurality of retail locations, but does so and as a monolith, without regard to whether demand is reflected in online or in store transactions. As described further below, the legacy forecast system 205 may be integrated within a multi-channel demand planner 202 and selectively used for validation or generation of demand forecasts in particular circumstances.

In the example shown, the forecast disaggregator 206 breaks down and overall demand forecast for online sales that is generated by the GAMM models 204 based on sales channels. Additionally the forecast can be broken down based on particular locations depending on the sales channel type. For example, in instances where an item, location specific demand forecast is desired, but where no individual location forecast is available for that item, or where the forecast requires further validation, a chain level forecast may be disaggregated to the individual location, according to various sales channels. Additionally, multi-channel demand forecasts at a particular location across a classification of items may be disaggregated to a particular item where data sparsity may suggest inaccuracy of a model at the item and location level.

The API 208 operates to provide access to information generated by the multi-channel demand planner 202 to various demand forecast consumers 220. For example, the API 208 may receive requests from various demand forecast consumers 220 requesting demand for a particular sales channel at a particular location, or across a group of locations. API 208 may also receive requests for item demand at a particular location across all sales channels. In response, the multi-channel demand planner 202 may provide, via the API 208, a response including a demand forecast broken down according to the requested sales channels, items, and locations.

In the example shown, a short life cycle product forecaster 210 is configured to predict demand for items that have not been previously offered for sale and our planned to only be offered for a brief period of time. The short life cycle product forecaster 210 relies on demand forecast generated by the multi-channel demand planner 202 to predict demand for short lifecycle products that are similar to existing products that are offered for sale by the retailer. Items having a short life cycle may correspond to items newly stocked at a particular location (which may have previously been stocked at other locations), or items that are newly introduced into the overall supply chain. The short lifecycle product forecaster 210 may take a variety of approaches to generating item demand forecasts, depending on the particular item. For example, an item newly introduced at a chain level may be forecast to have demand similar to other items within a common class, or items having common characteristics to the new item. An item newly introduced at a particular location may be forecast to have demand similar to the same item at other locations having similar demand or sales profiles. Such similar locations may include, for example, locations of similar size, having similar customer demographic or sales patterns, or other commonalities.

The computing device 216 is configured to provide inputs to the multi-channel demand planner 202 as well as receive outputs from the multi-channel demand planner 202. In some embodiments, the computing device 216 is configured to present a graphical user interface to a user.

The one or more sales data sources 218 provide sales data to the multi-channel demand planner 202. Examples of sales data sources include point of sales systems and online sales systems.

Demand forecast consumers 220 utilize information generated by the multi-channel demand planner 202 for various other functions such as inventory positioning, transportation planning, and sourcing. Demand forecasts consumers 220 may utilize computing devices, such as computing device 216, to display user interfaces illustrating forecast demand for particular items and locations. Additionally, demand forecasts consumers 220 may coordinate vendor ordering processes and transport processes (e.g., allocating transportation and other logistics services) on behalf of a retail enterprise. In some examples, the multi-channel demand planner 202 may provide demand forecasts via the API 208 to such demand forecast consumers 220, which may take individualized, automated actions in response to such forecasts. Notably, due to the individualized forecasts for demand across a variety of sales channels, such actions taken by demand forecast consumers 220 may be modified, for example to route items to particular locations within a retail enterprise, or otherwise to adjust demand for particular items at particular locations.

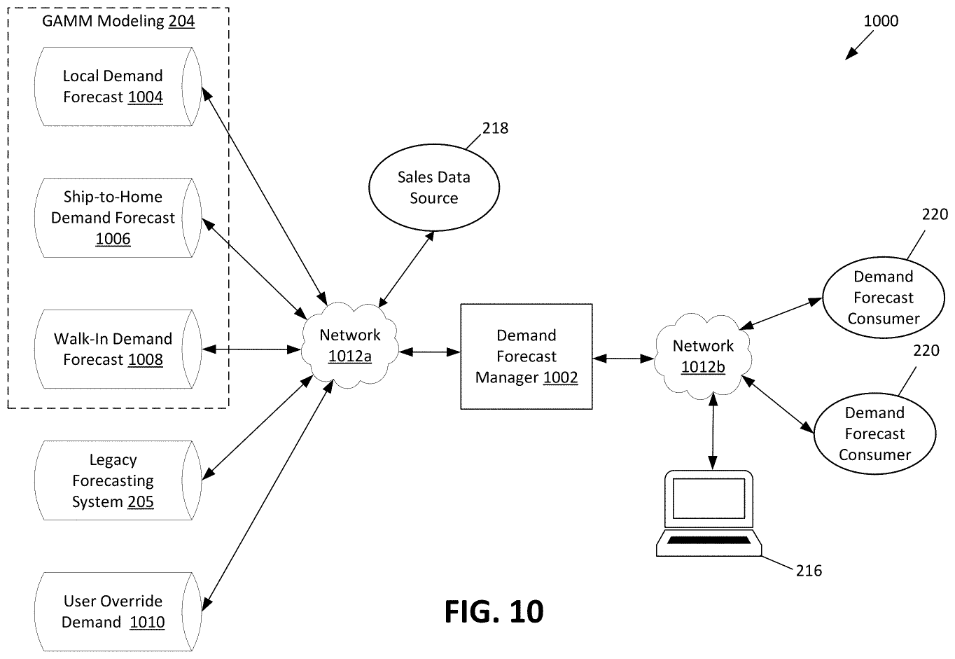

In some examples, the demand forecast consumers 220 may include user interfaces comprising displays depicting demand forecast data. For example, a user interface may include a forecasted demand from a legacy system and one or more forecasted demands from one or more of the GAMs (e.g., channel-specific demand forecasts and an aggregate demand forecast). Furthermore, in some embodiments, a demand forecast consumer 220 may provide a user override functionality, which a user may utilize to manually input a demand for an item. In some embodiments, the user input may override other forecasted demands, and the user override demand forecast may be sent to downstream systems (e.g. systems such as vendor ordering and transport systems, as described above). Example user interfaces and examples of a user override demand forecast are further described below in connection with FIGS. 10-19.

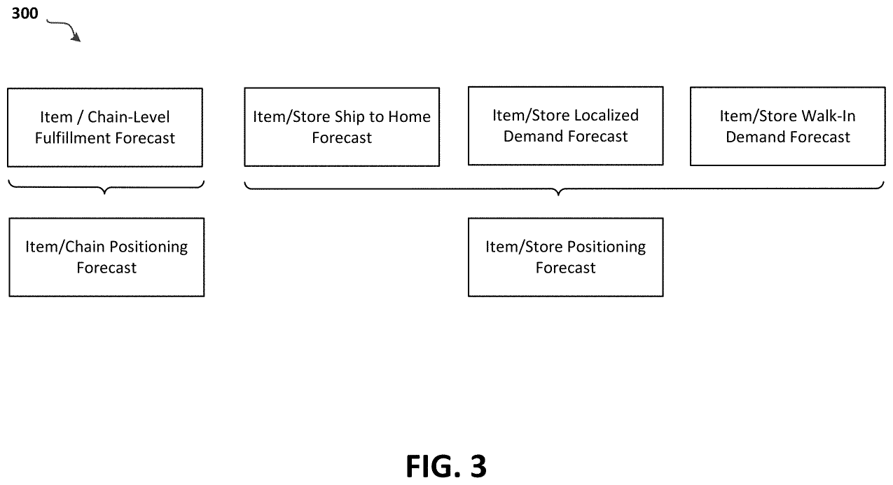

Referring now to FIG. 3, a logical diagram 300 is shown, depicting a breakdown of demand forecasts and relationship to item positioning. In particular, and as seen in the diagram 300, an overall item fulfillment forecast at the chain level (i.e., across an entire retail enterprise) may be used for positioning of items within a retail supply chain, including timing of orders, transportation of items from vendors to warehouses, and staging of items within warehouses. However, at the item store level (i.e., at a greater location granularity), different components of a demand forecasts may be used in different ways to arrive at an overall demand for an item at a particular location, and therefore may affect the positioning forecast for such an item. In particular, as illustrated, separate forecast components may include a forecast for items at a particular location that will be shipped to a customer's home; items at a particular location that will be picked up at that location by the customer, and therefore the store or retail location is fixed; and items at a particular location that are purchased from that retail location directly (e.g., walk in purchases). Although, in the legacy forecasting systems described previously, all three components are included in a given item location forecast, there is no ability to determine the portion of forecast demand that is attributable to sales from a retail organization that are not required to be fulfilled from the particular retail location. Accordingly, by separating a demand forecast into these components, a item positioning forecasts at the store or retail location level may be made more accurately across a supply chain that utilizes a large number of retail locations for both online and in store fulfillment.

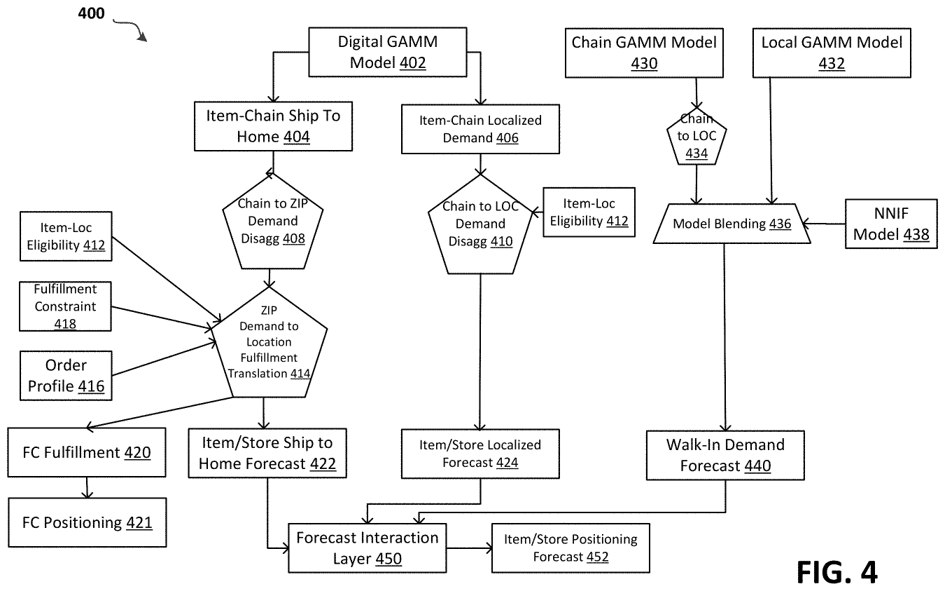

FIG. 4 is a flow chart of an example method 400 of using chain level and localized demand forecasting models to generate localized, multi-channel demand forecasts. The method 400 may be performed, for example, by the multi-channel demand planner 202 of FIG. 2, using the various models managed therein.

In the example shown, the method 400 is performed using a separate set of models for a digital forecast or online sales forecast, as well as for sales at a particular location. Regarding the digital forecast, a digital GAMM model 402 may be maintained, and can be used to generate a plurality of demand forecasts for a predetermined future time frame. In the example shown, the digital GAMM model 402 may be used to generate a ship to home demand forecast 404 at the item chain level, as well as a localized demand forecast 406 at the item chain level.

The ship to home demand forecast 404 is disaggregated from the chain level to a ZIP Code level at operation 408, while the localized demand forecast 406 is disaggregated from the chain level to a particular location level at operation 410. In this case, the particular location level corresponds to a retail location of the retail enterprise. In doing so, an item location eligibility 412 is used to attribute particular item demand to particular locations eligible to carry such items.

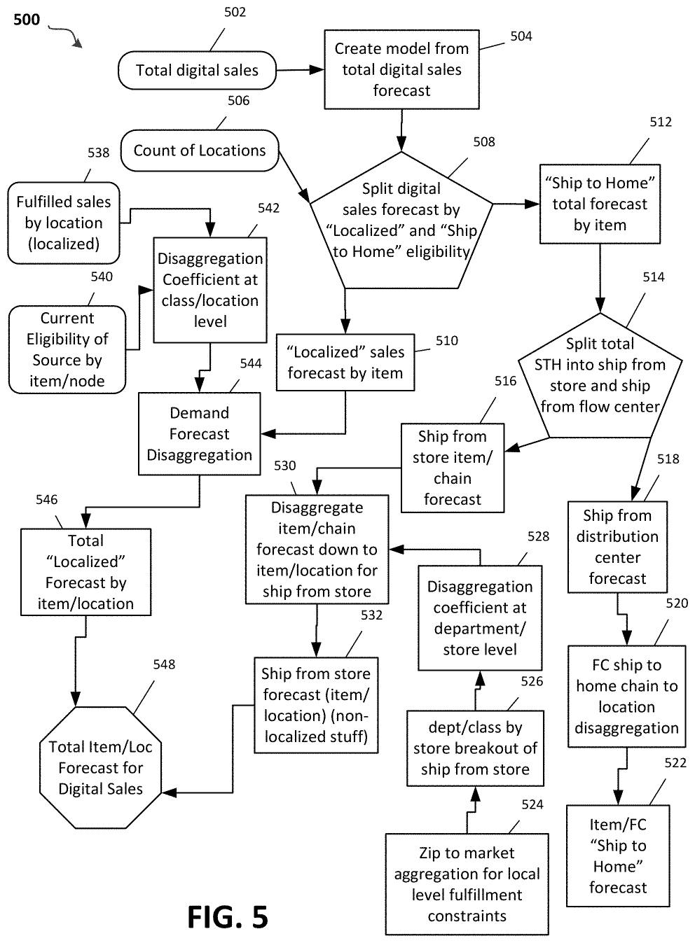

In example embodiments, disaggregation may be performed in a number of ways. In some examples, disaggregation may be performed based on historical proportions of sales of a given item at a particular time of year within a particular ZIP Code or from a particular retail location. In further examples, additional factors may be used, such as seasonal demand trends. Details regarding example disaggregation methodologies are provided in further detail below in conjunction with FIG. 5.

In the example shown, the portion of demand disaggregated from chain level to ZIP Code is associated with a particular retail location at operation 414. In example embodiments, the Association of ZIP Code-based demand to a store location is based on order profiles 416, fulfillment constraints for particular locations 418 (e.g., the extent to which a particular location may stock a predetermined number or admitted number of items at a given time), and item location eligibility 412 (whether a particular retail location stocks the item that is ordered in a ship to home digital order).

In the example shown, this location attributed ship to home demand is provided to a fulfillment system 420, which defines fulfillment of items from a warehouse, such as a flow center or distribution center. The fulfillment system 420 may use this demand for specific item positioning of items at a flow center, as well as planning for distribution of items from a flow center to stores or other retail locations, e.g., via an item positioning system 421. The location attributed ship to home demand is also provided as an item store ship to home forecast 422.

Concurrently, the item chain localized demand (i.e., online orders for which a customer may designate a particular store, such as for item pickup) which is disaggregated at operation 410 results in an item store localized forecast 424. Both the item store ship to home forecast 422 and the item store localized forecast 424 are provided to a forecast interaction layer 450, described below.

Concurrently, additional models may be used to determine other types of demand, such as walk in demand at a particular store locations. In the example seen in FIG. 4, in-store demand may be modeled using a chain model 430 as well as a local model 432. Both the chain model 430 and the local model 432 are generated on a per item basis. The use of the chain model may be to validate the local item model, or otherwise to assist when a local model may lack sufficient data to generate accurate forecasts for a particular item.

In the example shown, the chain model 430 is disaggregated at operation 434, to break down the chain level item specific demand to the location level. This disaggregated chain level demand and the local model 432 are provided to a model blending operation 436. The model blending operation 436 may combine the disaggregated chain level model and local model information, for example using a nearest-neighbor item forecast (NNIF) model 438, to generate a walk-in demand forecast 440 for a particular item at a particular location. The walk in demand forecast 440 is provided, alongside the item store ship to home forecasts 422 and the item store localized forecast 424 to the forecast interaction layer 450.

In example embodiments, the forecast interaction layer 450 may provide a user interface at which separate demand components for a given item may be visualized for any given item at any given location. Additionally, in some instances, the forecast interaction layer 450 may allow for re-aggregation of items, such that item demand may be viewed at a region or chain level. The forecast interaction layer 450 may receive a forecast timeframe, and identification of an item or class of items, and identification of a location or locations, and may generate a positioning forecast 452 for that combination of parameters. The positioning forecasts 452 may be used for purposes of item planning, for example in combination with ordering systems and lead time calculation systems to ensure that an appropriate selection and inventory of items is provided at each retail location at appropriate times.

Additionally, because separate components of a demand forecast are used as part of the positioning forecast 452, item positioning may be more flexibly managed, since some portion of the forecast demand is not necessarily required to be fulfilled from the particular store to which that demand is attributed. For example, at least the component of demand reflected in the item store ship to home forecast 422 may be adjusted in terms of positioning to accommodate any uncertainty or variability in demand at other locations.

FIG. 5 is a flow chart illustrating an example method 300 of planning for demand of items through multiple sales channels. In some embodiments, this method 300 is performed by the system of FIG. 1.

At operation 502, total digital sales are accessed from a data source. In some embodiments, the data source may correspond to online point-of-sale systems used by a retail enterprise.

At operation 504, the total digital sales for a given period of time are used to generate a model for forecasting total digital sales. In some embodiments, the model is a generalized additive model (GAM). In some embodiments, the GAM is a generalized additive mixed model (GAMM). In particular examples, multiple models may be generated. As noted above in conjunction with FIG. 4, both chain level and location level models may be generated for each individualized item. Because, in a example retail organization, hundreds of thousands to millions of items are carried and offered for sale, this may result in a significant number of models being generated, with multiple models generated for each item.

At operation 506, a count of locations in the supply chain is accessed from a data source. The total digital sales forecast generated by the model at operation 504 is split into two separate forecasts for the given time period. In some embodiments, the first forecast is for “localized” sales and the second forecast is for “ship to home” sales. The split is performed based on determining which items and locations are eligible for localized sales and which are eligible for ship to home sales. This may be defined, at least in part, based on a selected delivery mode by the customer. For example a customer may elect to pick up an item and store, or may elect to have the item shipped to their home. In some instances, items may only be eligible for pickup in-store, while other items may only be eligible for shipment to home.

At operation 510, the localized sales forecast is generated. Localized sales refers to digital sales that are made for fulfillment by a particular location within the supply chain. In other words, when an order for one or more items is made online, a particular retail store is selected to fulfill that order. For example, a customer may place an order for items that he or she wants to pick up from a particular store located near his or her home. Examples of digital sales that are localized can include orders made for pick up at a particular retail store (whether by in-store pick-up, drive-up pick-up, or other means by which a customer can pick up an order at a store) as well as orders placed for delivery to a customer where the items of the order are obtained at a given store (e.g., for delivery via a third party delivery service, such as a crowdsourced third party delivery service). In some embodiments, the localized digital sales also includes digital orders that are placed to pick up items at a given store even though that store may not have the items in stock. The ordered items are shipped from warehouses, distribution centers, or other stores to the store selected by the customer. When the order has arrived at the store, the customer receives a notification and can go pick up the order.

At operation 512, the ship to home (STH) forecast is generated. STH sales for digital orders are considered to be non-localized sales because it does not matter to the customer which location the item originates from. For traditional orders for items to be delivered to a customer in two or more days, the items are sourced from distribution centers, warehouses, other stores, etc. and are shipped directly to the customer. Where the items originate from is limited only by the promised delivery date. Thus, the digital demand associated with these orders is not attributable to any particular location within the supply chain.

At operation 514, the total STH forecast is split into a ship from store forecast 516 and a ship from distribution center forecast 518. The STH forecast may be split based on which stores and which distribution centers carry a particular item, as well as the geographic proximity of a store for distribution center to the ZIP Code associated with a particular order. In some embodiments, this process is performed by the forecast disaggregator 206 of FIG. 2. The ship from store forecasts 316 are generated at the chain level for each item for the given time period. Similarly, the ship from distribution center forecasts 318 are generated at the chain level for each item for the given time period.

At operation 520, the chain level forecast for ship from distribution center sales is disaggregated down to an individual location level. In some embodiments, this operation can be performed by the forecast disaggregator 206 of FIG. 2. This results in an item/distribution center forecast 522, for ship from distribution sales on a per item basis.

The item/distribution center forecasts 522 account for all digital sales that are non-localized and thus are not attributed to any particular retail store. Each location still has its own forecast, but it is based on sales that could be fulfilled at other locations.

At operation 524, orders for a particular item, which are attributed to specific ZIP codes, are aggregated to and attributed to a specific location (e.g., a retail store location). By aggregating such historical ship to home orders into store-specific ship-to-home orders, it can be determined if the particular local store could fulfill that demand or whether the demand levels for a particular item may violate any local fulfillment constraints. At operation 526, a further aggregation may be performed to aggregate demand that was determined in operation 524 at a department or class level.

At operation 528, a disaggregation coefficient at the department/store level is created, based on the department/class level demand breakout by store. The disaggregation coefficient that is generated at the department/store level can then be used, in operation 530, to disaggregate the chain/item forecast determined in operation 516 (for ship from store sales) down to the item/location level. This results in the ship from store forecast 532.

At operation 538, historical, fulfilled sales by location are accessed. At operation 340, current eligibility by source of each item/node combination is accessed. Based on historical fulfilled sales, and the current eligibility of a source location by item, a further disaggregation coefficient may be determined at operation 542 at the class/location level. The localized sales determined in operation 510 may then be disaggregated from a chain level to store or retail location level using the disaggregation coefficients, at operation 544. This results in a total localized forecast 546, by item and location.

At operation 548, the total localized sales forecast from operation 546 is combined with the ship from store forecast from operation 532. This results in a total forecast for digital sales at the item/location level. This digital forecast is adjusted to account for digital sales that should be attributed to particular retail stores.

Referring to FIG. 5 generally, it is noted that the methods of creating location-specific, per-item demand forecasts that are separable not only into store sales, but also into both localized and non-localized online demand, improves both the overall accuracy of a forecast by determining what portions of overall future demand must be fulfilled from particular locations, and what portion of overall future demand may be attributable to a location but not necessarily tied to that location, and therefore, in conjunction with any constraints on retail locations or volumes of items that may flow within a physical supply chain, forecasts may be tied to item planning processes in a way that can ensure appropriate local placements of items. For example, an item placement planning system may utilize this improved forecasting to adjust a location for items that may be shipped to home from a store, e.g., by changing a location or placement of the item among stores near a forecast ZIP code from which an order will be received where constraints might otherwise have prevented item stocking.

### III. Demand Forecasting System and Model Management

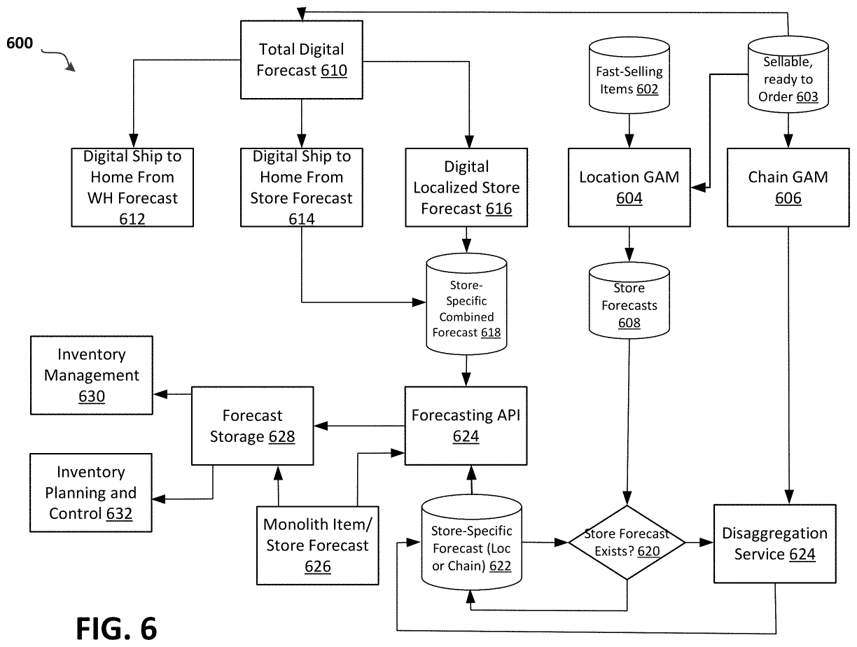

Referring now to FIGS. 6-9, additional details are provided regarding an architecture and environment in which demand forecasting models may be managed and selected for use, as well as instances in which such models may be updated in a manner that is sensitive to the specific item to which the model is directed. That is, based on the specific item characteristics (e.g., whether a new item, a fast-selling item, an item with inadequate sales history, a slow-selling item, a seasonal item, or an item that is stocked in fewer than all retail locations), a model may be created, maintained, and trained in different ways. This ensures accuracy of each model while reducing the significant computing demands caused by frequent retraining of each model. Since the models described herein are generally created on a per-item, per-location basis, within a large supply chain, retraining processes would otherwise be significantly more computationally burdensome.

FIG. 6 is an architecture diagram of a multi-channel demand planning system 600 within which aspects of the present disclosure may be implemented. The multi-channel demand planning system 600 may be used as system 200 of FIG. 2, and in particular, for model creation and management of the various GAM models maintained within that system.

In the example shown, sales data sources including a fast selling items database 602 and a sellable items database 603 may be used to create a location-specific GAM model 604 and a chain-level GAM model 606 for each item within a supply chain. The location-specific GAM models may be used to generate store forecasts 608.

In the example shown, a total digital forecast 610 is drawn from the sellable items database 604, and is broken down into a ship to home from warehouse forecast 612, ship to home from store forecast 614, and digital localized store forecast 616. Store-specific combined forecasts may be created from the ship to home from store forecast 614 and digital localized store forecast 616, and stored in a store-specific combined forecast database 618.

Concurrently, store forecasts for best-selling items at particular locations may be assessed, and, if such store forecasts exist (at operation 620) they may be stored in a store forecasts database 622. If no store forecasts exists, a disaggregation service 624 will receive the chain-level GAM model 606, and create store level forecasts for storage in the database 622.

In the example shown, the store forecasts in database 622 and the store specific combine forecasts stored in database 618 are accessible via a forecasting API 624. The forecasting API also receives a per item store forecasts for item demand from a monolith forecasting system 626, which does not subsegment walk in or in store demand. A forecast storage system 628 will store per item, per location forecasts for each item and each location for a predetermined amount of time into the future.

Such stored forecasts may be accessible to an inventory management system 630 as well as an inventory planning and control system 632. The inventory management system 630 may manage movement of items among locations within a retail supply chain, while the inventory planning and control system 632 may plan for, and in some instances automatically reorder, items based on demand expected to occur. In both instances, one or more forecasts for the item, as retrieved from databases 618, 622 or as retrieved from the monolith forecasting system 626, may be provided such that on overall demand for at the item may be determined, as well as portions of demand that are associated with different types of digital order online orders. In examples, the inventory management system 630 and inventory planning and control system 632 may implement aspects of the positioning operations 421,452 described above in conjunction with FIG. 4.

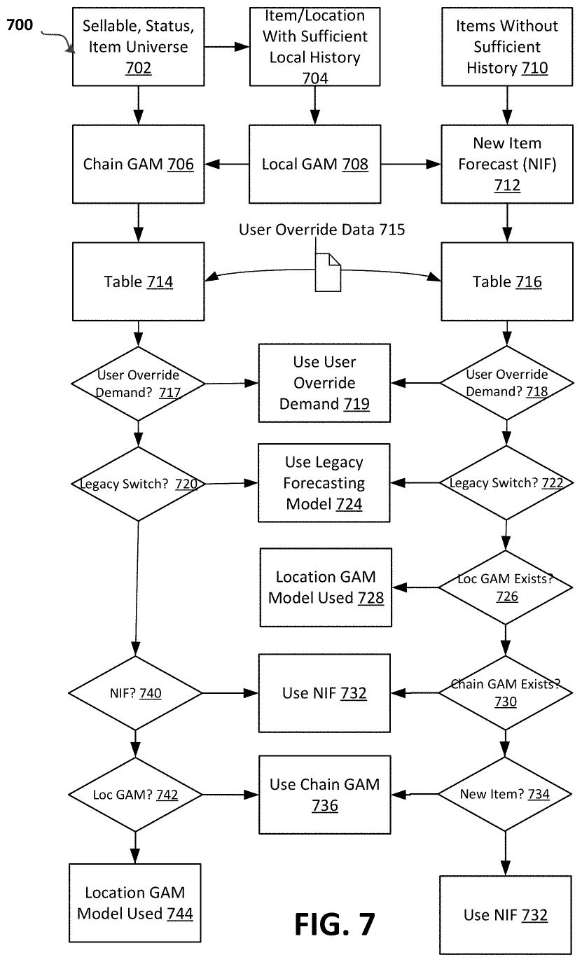

FIG. 7 is a logical flow diagram illustrating a system 700 for selection among a plurality of different demand forecast models within the multi-channel demand planning system described herein. In some embodiments, the system 700 may be used for selecting a user override demand forecast, rather, in some embodiments, than one or more of the demand forecast models. The system 700 may be used, for example, at the forecasting API 624 and forecast storage system 628 to determine an appropriate forecast to be used in response to a request for a particular forecast from an external system such as an inventory planning and control system or an inventory management system as described above.

In the example shown, a universe of sellable items 702 may be used to generate a chain level model, such as a chain GAM 704. The universe of syllable item 702 may also be used to access item location information 706, to determine whether each location has sufficient item sales history to generate a location specific demand model. If so, a local model, such as a local GAM 708, may be generated.

Additionally, for items that lack sufficient sales history 710 either at the location level or at the chain level, a new item forecast (NIF) 712 is generated. The new item forecast 712 may be generated at the local level, and may be informed by local demand that is modeled for other, similar items. In some instances, such local, similar items may be items within a common class and at a common price point to the new item that is forecasted. Upon creation of the models, tables 714, 716 are created that provide a listing of the models that are available for use, including models for each item at each location, as well as models at coarser granularity, such as a class level, region level, department level, etc. In some embodiments, the tables 714, 716 may also include user override data 715. The user override data 715 may correspond to one or more user-specified item demand forecasts. In some embodiments, a user override demand forecast may be localized to one or more particular locations (e.g., stores) within the example supply chain of FIG. 1. In some embodiments, the system 700 may receive the user override data via a user interface. User override demand forecasts are further described below in connection with FIGS. 10-19.

After models are created, a series of operations may be performed to determine whether there is a user override demand forecast or to determine which model would be most appropriate for use. The operations may be performed, in some embodiments, by the multichannel demand planner 202 of FIG. 2, such that demand forecast consumers 220 may receive one or more demand forecasts from a unified system, but may not be required to select from among a plurality of similar demand forecasts. Rather, the multichannel demand planner 202 may select an appropriate demand forecast (and, in some embodiments, associated model) on behalf of the requesting entity, thereby simplifying the external process while exposing additional granularity as to the channel on which demand is expected, where available.

In some embodiments, the system 700 may, prior to the first set of operations 720, 722, determine whether to use a user override demand forecast. In some embodiments, if a user override demand forecast is available for an item, then the user override demand forecast is used, thereby giving user override demand forecasts priority over model-based demand forecasts. In some embodiments, the determination of whether to use a user override demand forecast may depend on details of a user override for an item. For example, data corresponding to the user override demand forecast may indicate that the user override demand forecast is to be used during defined time periods, such as certain weeks. The determination of whether to use a user override demand forecast can be performed on a per item basis, a per location basis, on the basis of both item and location, or on some other basis (e.g., by department, or globally within the enterprise). If it is determined at either the operation 717 or the operation 718 to utilize a user override demand forecast, then the appropriate user override demand forecast (e.g., based on the time frame, item or items, location or locations, etc.) is selected at the operation 719. By selecting the user override demand forecast, the system 700 may, in some embodiments, select the user override demand as the expected demand for the item for a time period specified by the user override demand forecast, as is further described below.

At a first set of operations 720, 722 a determination of whether to utilize a legacy forecasting system is performed. The determination of whether to use the legacy forecasting system may be set by a model manager (e.g., in a human-defined or automated manner), or based on the relative expected accuracy of the legacy modeling and the GAM modeling described herein. This determination of whether to use a legacy forecasting system can be performed on a per item basis, a per location basis, on the basis of both item and location, or on some other basis (e.g., by department, or globally within the enterprise). Such operations allow an enterprise to gradually migrate from a legacy demand forecasting model to a multichannel demand forecasting arrangement such as described herein, without requiring that all items and locations are modeled using the multichannel modeling before its use for any forecasting. If it is determined at either operation 720, 722 to utilize a legacy forecasting system, a legacy forecasting model is accessed at operation 724, and provided the requested parameters (e.g., the timeframe, item or items, location or locations, etc.) to generate an appropriate forecast.

Operation 726 determines whether, for a given item, a location-specific GAM model is available. If such a model is available, at operation 728 such a location GAM model is used. If no such model is available, a further operation 730 determines whether a chain GAM model exists. If a chain GAM model does not exist, a new item forecast model is used at operation 732. If a chain GAM model does exist, however, at operation 734 it is determined whether the item is a new item. If the item is not a new item, the chain GAM model determines to exist in operation 730 is used in operation 736. If the item is a new item, at operation 738 the new item forecast model is used, irrespective of whether a chain GAM model is available.

In example embodiments, operations 722, 726, 730, and 734 are utilized in the circumstance that a location specific GAM model is available for the identified item. However, in some instances only a chain level GAM model is available for a given item, and a demand forecast is generated from that model using disaggregation techniques as described above. In the circumstances, a slightly different ordering of determinations of an appropriate model may be utilized. In particular, following operation 720, it may be determined at operation 740 whether a new item forecast model exists for the item. If so, the new item forecast model is used at operation 732 as above. If no new item forecast model is available, it is determined whether a location specific GAM model is available at operation 742. In this case, the location specific GAM model may be a disaggregated model for a particular item, class, etc. Such a model may be used, if available, at operation 744. If no location specific GAM model is available, the chain GAM model may be used, at operation 736 as noted above.

Referring to FIG. 7 generally, the determination of whether an item is a new item may be based on one or more criteria. For example, an item may be designated as a new item if that item has less than a predetermined amount of prior sales history available for it. In some examples, this may be an item having less than 52 weeks of sales history, or in some instances less than 12 to 24 weeks of sales history. In further examples, the determination of whether an item is a new item is configurable or adjustable, and may be based on both the amount of time the item has been offered for sale and volumes of sales of that item.

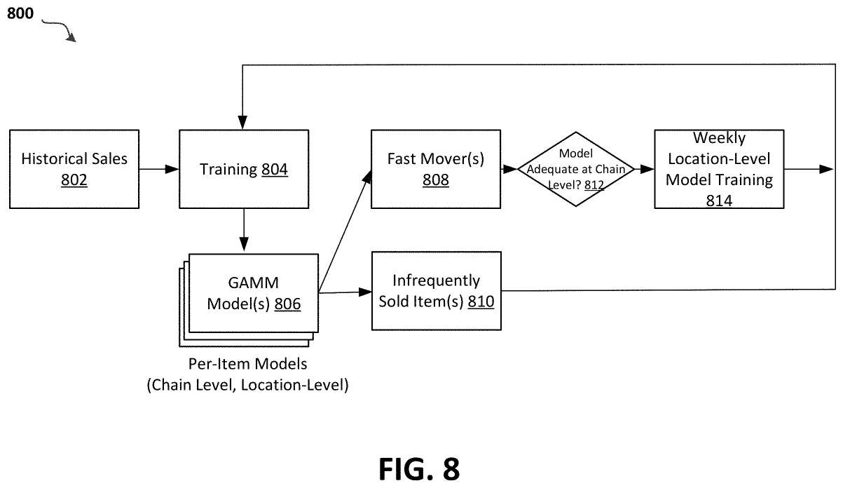

FIG. 8 is a logical flow diagram illustrating example performance optimization processes 800 for managing individual demand forecasting models, in example embodiments. The performance optimization processes 800 described herein may be used for management and updating of the GAM models described herein, and in particular are useful in reducing computing loads where large numbers of GAM models are maintained (e.g., in a large retail organization).

In the example shown, historical sales 802 are access to generate training data sets 804 for creation of GAM models 806 (in some instances, GAMM models) on a per item basis. These models may be, as noted above, either generated for a chain level, or a location level, or both. Accordingly, there are a large number of models that are generated and maintained. Depending on characteristics of the item, different models may be updated at different rates to manage the extent to which computational resources are required to be used. In typical cases, models may be updated on a regular or semi regular basis, e.g., daily or weekly.

In the example shown, the GAM models 806 may be separated into models associated with fast-moving items 808 (e.g., paper towels, bananas, other stable items) and infrequently sold items 810 (e.g., outdoor furniture, etc.). For fast-moving items 808, it is determined whether a model available at the chain level is adequate for obtaining an accurate demand forecast, at operation 812. If use of a chain level forecasts (e.g. and disaggregated as described herein) is not adequate, then a weekly location level model training process 814 can be performed for those items. However, if the chain level forecast model is adequate for particular items, creation of an additional model at the location level is unnecessary, and can be avoided to reduce compute time.

By selecting particular models for regular updating and excluding certain other models (e.g. models that will not change significantly between training periods) and overall improvement in location level training time may be gained. In some instances, up to 2-3 times less training time is required to achieve similar model accuracy.

In some example embodiments, rather than re-training an entire model, additionally for some items each model may be incrementally trained using newly available data. Still further, rather than performing a scoring process on each model as part of the training, scoring may be performed on less than the entire item universe each time a model is retrained or re-created. Still further, as part of the retraining process, the various models may be trained on distributed computing systems, for example using Apache Spark.

In some further example embodiments, for particular models that require a significant amount of training time (e.g., greater than one hour), such models may be eliminated, thereby allowing the system to selectively choose to use a chain level model for that item, or otherwise use a classification level model for the item, thereby using the item classification as a proxy for the item itself when forecasting item demand.

Referring to FIGS. 1-8 generally, it is noted that the ability to separately consider item demand on a per location basis across a variety of sales or delivery channels provides a number of computational advantages with respect to accuracy of the overall system. For example, in previous systems, a particular retail location would be credited with an online sale if the item is shipped from that particular retail location to the customer, since the transaction occurred from that retail location. However, in the current forecasting arrangements, non-localized demand that is in fact fulfilled from a particular retail location is no longer attributed to that particular retail location necessarily, but can be considered non-localized and accounted for on a more general basis (e.g., from any of a variety of retail locations or warehouses that may be able to fulfill that particular component of demand).

Similarly, in circumstances where a customer visits a retail location to purchase an item but that item is out of stock so the customer purchases the item online for shipment from a warehouse, previous systems would not have accounted for this as location-specific demand, but instead would credit the demand to whatever store or warehouse in fact fulfilled the order, irrespective of whether that would be the best place location for order fulfillment. This may lead to improved accuracy in future item placement within a retail supply chain.

Still further, online orders shipped directly from a warehouse, such as a distribution center, will be considered non-localized demand. However, the use of, and tying such orders to order destination ZIP Codes, allows for better localization of such orders such that, in the future, allocation of items throughout a retail supply chain may be plan to such that the item could be closer to the customer in the future (e.g., at a different warehouse or at one or more retail locations that are closer to the customer and therefore more responsive, and able to ship at lower cost).

Furthermore, as customer buying trends change, the demand shift of store-attributed demand to entirely digital (non-localized) can be quantified and tracked over time.

### IV. Example Computing Systems for Implementing Demand Forecasting

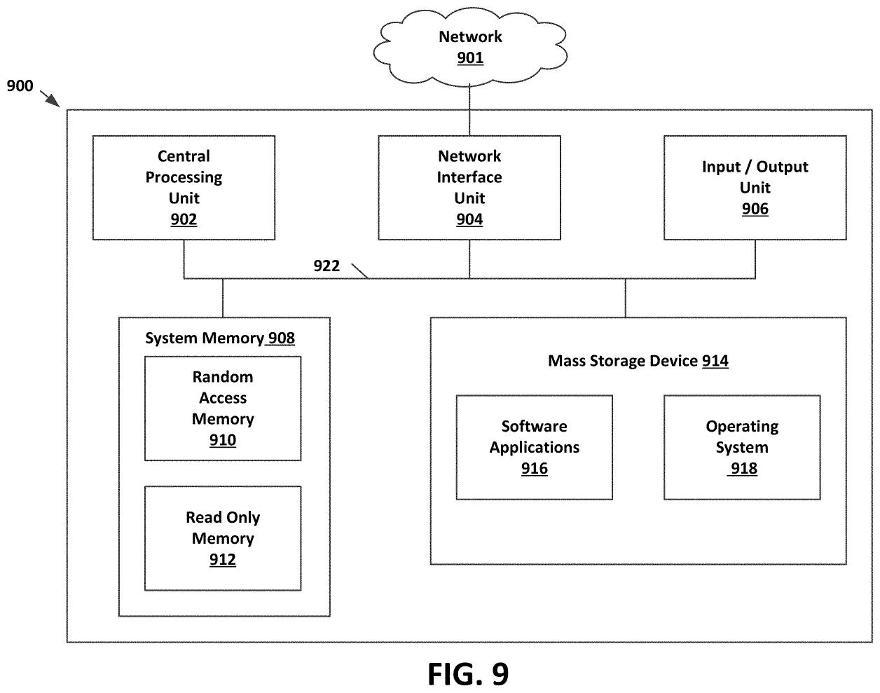

Referring now to FIG. 9, an example block diagram of a computing system 900 is shown that is useable to implement aspects of the computing system 200 of FIG. 2. In the embodiment shown, the computing system 900 includes at least one central processing unit (“CPU”) 902, a system memory 908, and a system bus 922 that couples the system memory 908 to the CPU 902. The system memory 908 includes a random access memory (“RAM”) 910 and a read-only memory (“ROM”) 912. A basic input/output system that contains the basic routines that help to transfer information between elements within the computing system 106, such as during startup, is stored in the ROM 912. The computing system 106 further includes a mass storage device 914. The mass storage device 914 is able to store software instructions and data.

The mass storage device 914 is connected to the CPU 902 through a mass storage controller (not shown) connected to the system bus 922. The mass storage device 914 and its associated computer-readable storage media provide non-volatile, non-transitory data storage for the computing system 106. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 902 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing system 106.

According to various embodiments of the invention, the computing system 106 may operate in a networked environment using logical connections to remote network devices through a network 901, such as a wireless network, the Internet, or another type of network. The computing system 900 may connect to the network 922 through a network interface unit 904 connected to the system bus 922. It should be appreciated that the network interface unit 904 may also be utilized to connect to other types of networks and remote computing systems. The computing system 900 also includes an input/output controller 906 for receiving and processing input from a number of other devices, including a touch user interface display screen, or another type of input device. Similarly, the input/output controller 906 may provide output to a touch user interface display screen or other type of output device.

As mentioned briefly above, the mass storage device 914 and the RAM 910 of the computing system 106 can store software instructions and data. The software instructions include an operating system 918 suitable for controlling the operation of the computing system 106. The mass storage device 914 and/or the RAM 910 also store software instructions, that when executed by the CPU 902, cause the computing system 900 to provide the functionality discussed in this document. For example, the mass storage device 914 and/or the RAM 910 can store software instructions that, when executed by the CPU 902, cause the computing system 900 to receive and analyze inventory and demand data.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

### V. Example Features of Demand Forecasting System

Referring now to the FIGS. 10-19, further example features of a demand forecasting system is described. In some embodiments, the demand forecasting system may include functionality to generate one or more user interfaces. The user interfaces may include one or more demand forecasts for an item. In some embodiments, the demand forecasts for an item may be generated from one or more of the GAM models 204 or the legacy forecasting system 205. In some embodiments, a user may override a demand forecast by using aspects of the one or more user interfaces.

FIG. 10 illustrates a schematic diagram of a system 1000 for planning item demand. In some embodiments, the system 1000 includes aspects of the system 200 of FIG. 2. In some embodiments, the system 1000 includes aspects off the system 700 of FIG. 7. In the example of FIG. 10, the system 1000 includes a demand forecast manager 1002. The demand forecast manager 1002 may be communicatively coupled via the network 1012a with the sales data source 218, each of the components 1004-1008, the legacy forecast system 205, and a user override demand forecast database 1010. Furthermore, the demand forecast manager 1002 may be communicatively coupled via the network 1012b with the demand forecast consumers 220 and the computing device 216, each of which are further described above in connection with FIG. 2. In some embodiments, one or more of the networks 1012a-b may be part of the network 212 of FIG. 2.

The demand forecast manager 1002 may, in some embodiments, include components of one or more of the multi-channel demand planner 202, a demand forecast consumer 220, or the computing device 216. In some embodiments, however, the demand forecast manager 1002 may be communicatively coupled to—but a separate component from (e.g., a separate system of software, hardware, or combination of software and hardware)—the multi-channel demand planner 202, the demand forecast consumer 220, and the computing device 216. In some embodiments, the demand forecast manager 1002 may be communicatively connected to the network 212. In some embodiments, the computing system 900 is useable to implement aspects of the demand forecast manager 1002.

The demand forecast manager 1002 may receive demand forecast data from a plurality of sources and display one or more user interfaces related to viewing or managing demand forecasts. In some embodiments, the demand forecast manager 1002 may receive historical sales data from the sales data source 218. For example, the demand forecast manager 1002 may receive previous sales data that is disaggregated by item, location, and time period. As an example, the historical data may be average sales for “Brand X Baby Wipes, 40 ct.” at a “Springfield” location over the past certain number of years.

In some embodiments, the demand forecast manager 1002 may receive model-based demand forecasts. The model-based demand forecasts may include a predicted number of units of an item sold at one or more locations over a period of time. For example, the demand forecast manager 1002 may receive one or more demand forecasts from one or more of the GAM models 204. As illustrated in the example of FIG. 10, the demand forecast manager 1002 may receive local demand forecast data 1004, ship-to home demand forecast data 1006, and walk-in demand forecast data 1008, each of which may be generated form one or more of the GAM models 204. In some embodiments, the demand forecast manager 1002, or another component, may combine data from one or more GAM models 204 as an overall model-based demand forecast for an item (e.g., a forecast that includes demand from various channels, such as localized demand, ship-to-home demand, and walk-in demand). In some embodiments, data received from the components 1004-1008 may be disaggregated so that it is specific to a particular item, location, region, time period, or other classification. Architecture and operations of the GAM models 204 are further described above in connection with FIGS. 2-8.

In some embodiments, the demand forecast manager 1002 may receive data from the legacy forecasting system 205, such as a legacy demand forecast for an item. In some embodiments, the legacy demand forecast for an item may include a predicted number of units of an item sold at one or more locations over a period of time. In some embodiments, the demand forecast manager 1002 may call the API 208 to receive data from the one or more GAM models 204 or the legacy forecasting system 205.

In some embodiments, the demand forecast manager 1002 may receive data from the user override demand forecast database 1010. The user override demand forecast database 1010 may include user-defined predictions of a number of units of one or more items sold at one or more locations during one or more time periods. In some embodiments, a user override demand forecast may include an item and one or more override values for one or more time periods. Each of the override values may be a user-defined prediction of a number of units of the item sold during a corresponding time period of the one or more time periods. In some embodiments, the user override demand forecast may be for an item at a particular location (e.g., a location depicted in FIG. 1, such as a store). In some embodiments, the user override demand forecast may apply to a plurality of locations, to a region, or to a supply chain more generally. In some embodiments, a user may input a user override demand forecast via a user interface of the demand forecast manager 1002, as is further described below.

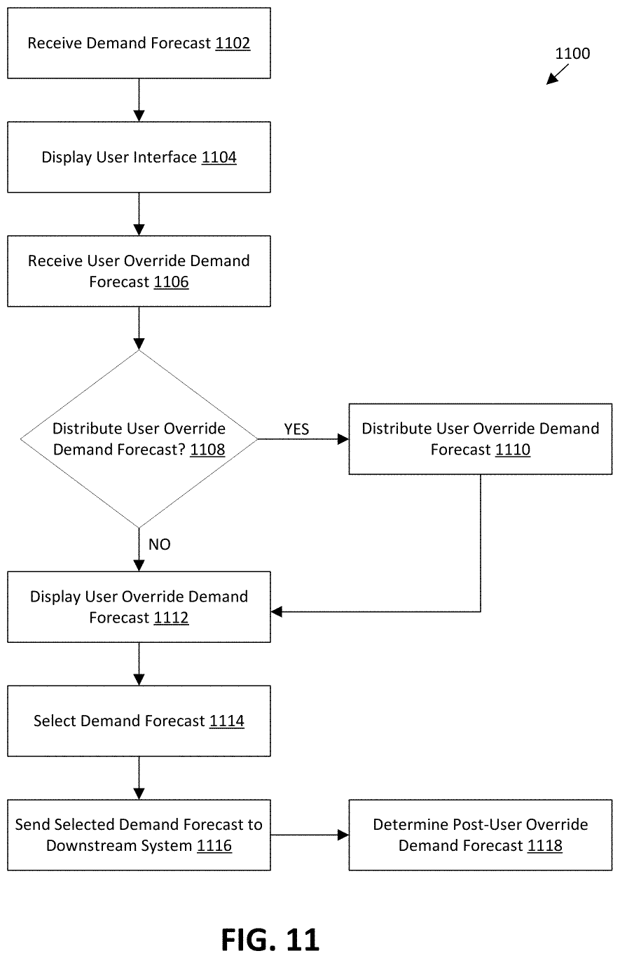

In some embodiments, the demand forecast manager 1002 may perform a variety of operations related to forecasting item demand. For example, the demand forecast manager 1002 may display—or cause a display of—a plurality of user interfaces. To do so, the demand forecast manager 1002 may, in some embodiments, use the computing device 216 or a demand forecast consumer 220. Furthermore, the demand forecast manager 1002 may, in some embodiments, provide a user override functionality for overriding a forecasted demand for one or more items. To do so, the demand forecasting manager 1002 may use the one or more user interfaces. Having received a user override demand forecast, the demand forecast manager 1002 may also, in some embodiments, perform other operations related to the user override demand. For example, the demand forecast manager 1002 may perform one or more of distributing the user override demand forecast to one or more locations, displaying aspects of the user override demand forecast, selecting the user override demand forecast (e.g., as described above in connection with FIG. 7), or sending the user override demand forecast to one or more downstream systems, such as the demand forecast consumers 220. Aspects of the demand forecast manager 1002 are further described below in connection with FIGS. 11-18

FIG. 11 is a flowchart of an example method 1100. In some embodiments, the method 1100 may be performed by the demand forecast manager 1002 to forecast demand for one or more items.

In the example shown, the demand forecast manager 1002 may receive one or more demand forecasts (step 1102). In some embodiments, the demand forecast manager 1002 may receive a model-based demand forecast for an item. For example, the demand forecast manager 1002 may receive a demand forecast from one or more GAM models 204, a combination of GAM models 204, or from the forecast disaggregator 206. In some embodiments, the demand forecast manager 1002 may receive a demand forecast from one or more legacy forecasting systems. In some embodiments, the demand forecast manager 1002 may call an API to receive demand forecast data from another system (e.g., calling the API 208 to receive demand forecast data from the multi-channel demand planner 202).

The demand forecast received by the demand forecast manager 1002 (e.g., a model-based demand forecast or a legacy demand forecast) may include, for an item, one or more predicted demand values for one or more time periods. In some embodiments, the predicted demand values may be a predicted number of units of the item that will be sold. Each of the one or more time periods may be a span of time, such as a day, week, or month. The one or more time periods may be past, current, or future time periods. In some embodiments, the demand forecast manager 102 may receive a demand forecast for a particular item or a demand forecast for a plurality of items (e.g., for a class or department of items) that may be disaggregated to determine a demand forecast for a particular item. In some embodiments, the demand forecast manager 1002 may receive a demand forecast for a particular location or a demand forecast for a plurality of locations that may be disaggregated to determine a demand forecast for a particular location. In some embodiments, the demand forecast manager 1002 may receive channel-specific demand forecast data. For example, the demand forecast manager 1002 may, for an item, receive a localized demand forecast, a ship-to-home demand forecast, and a walk-in demand forecast. In some embodiments, the demand forecast manager 1002, or a different component of the present disclosure, may aggregate the channel-specific demand forecasts to determine an overall model-based demand forecast.

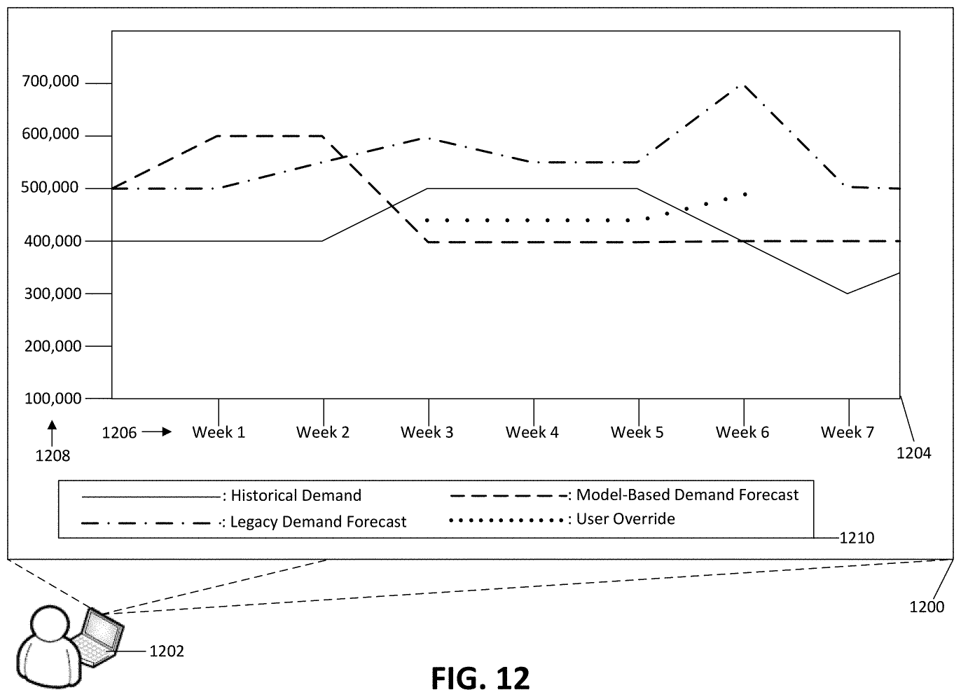

In the example shown, the demand forecast manager 1002 may display a user interface (step 1104). In some embodiments, the user interface may include a demand forecast display. The demand forecast display may include the demand forecast received by the demand forecast manager 1002. In some embodiments, the display may be a graph, chart, table, or another type of display that may include forecasted demand data. In some embodiments, the demand forecast manager 1002 may display the user interface via the computing device 216 or a demand forecast consumer 220. In some embodiments, the demand forecast manager 1002 may display a plurality of user interfaces. In some embodiments, one or more of the user interfaces may include one or more input fields for overriding a demand forecast (e.g., for overriding a model-based demand forecast, a demand forecast from a legacy system, or a previous user override demand forecast). In some embodiments, the demand forecast manager 1002 may automatically display the one or more input fields for overriding a demand forecast in response to receiving, via the user interface, a request to input a user override demand forecast. Example user interfaces displayed by the demand forecast manager 1002 are further described below in connection with FIGS. 12-18.

In the example shown, the demand forecast manager 1002 may receive a user override demand forecast (step 1106). In some embodiments, the user override demand forecast may be a user-defined predicted demand for an item over one or more time periods that overrides another demand forecast, such as a model-based demand forecast, a legacy demand forecast, or a previous user-defined demand forecast. In some embodiments, the demand forecast manager 1002 may receive the user override demand forecast via the user interface. In some embodiments, the user override demand forecast may be sent from a user to a system, such as the user override demand database 1010, and then to the demand forecast manager 1002. In some embodiments, the user override demand forecast may be sent as a structured data file, such as CSV file or an xlsx file.

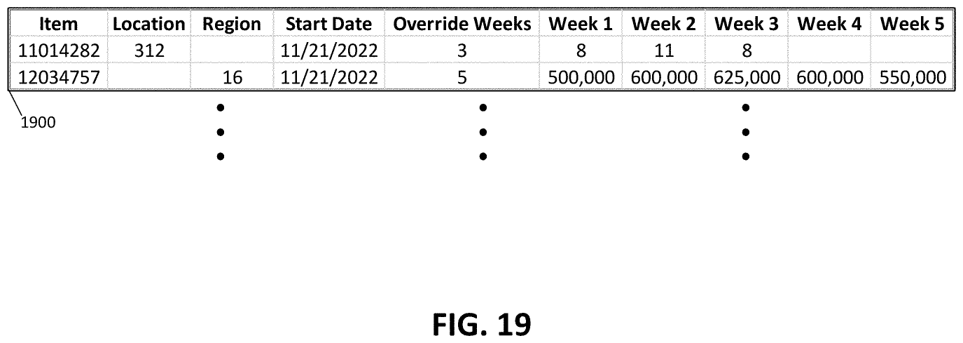

In some embodiments, the user override demand forecast includes one or more of the following: one or more items; one or more override values for one or more time periods; one or more locations; one or more reason codes; post-user override demand forecast data; or other data that may relate to defining a demand of one or more items. Example data corresponding to a user override demand forecast is illustrated and described below in connection with FIG. 19.

An item of the user override demand forecast may, in some embodiments, be a product sold by a retailer. In some embodiments, the item may be identified by a name, a unique identifier, a hierarchy of identifiers (e.g., department, class, category, item, etc.), or by one or more selections in an item identification or selection filter. In some embodiments, the user override demand forecast may include a plurality of items (e.g., a category of items or a group of individually selected items).

Each of the one or more override values may, in some embodiments, be a user-defined predicted demand for the one or more items during a corresponding time period of the one or more time periods. In some embodiments, the user override values may be a number of units of the one or more items that are predicted to be sold. In some embodiments, the override values may be a percentage increase or decrease from a baseline value. In some embodiments, the override values may indicate how an aggregated demand (e.g., a demand for a plurality of stores) is distributed to a plurality of locations. As an example of override values, for a user override demand forecast, a first user override value may indicate that 10 units of Brand X Baby Wipes, 40 ct., are expected to be sold during a first time period (e.g., the first week of April), and a second user override value may indicate that 8 units of Brand X Baby Wipes, 40 ct., are expected to be sold during a second time period (e.g., the second week of April).

In some embodiments, one or more of the user override values may be for a channel-specific demand. For example, an override value may be for one or more of a walk-in demand, ship-to-home demand, or a localized demand. For instance, if a user knows that a location cannot provide a ship-to-home service for a period of time, then the user may set the channel-specific user override demand forecast for items at that store to be zero. In some embodiments, the demand forecast manager 1002 may combine channel-specific user override demand values with channel-specific model-based demand values to determine an aggregate demand value for an item (e.g., combining a user-defined ship-to-home demand value for an item with a model-based localized and walk-in demand value for the item).

The one or more time periods of a user override demand forecast may, in some embodiments, include a start date, a duration, and an indication of the relevant measure of time (e.g., days, weeks, months, etc.). If, for example, the relevant measure of time is weeks, then the user override demand forecast may include a number of weeks that the user override demand forecast is applicable. As an example, the user override demand forecast may start on Apr. 2, 2023, and it may last for five weeks. Each of the five weeks may, in some instances, correspond with an override value (e.g., a predicted number of units of an item) of the user override demand forecast.

The one or more locations of a user override demand forecast may, in some embodiments, be a single retail store, a region that includes a plurality of stores, or a supply chain (e.g., the example supply chain of FIG. 1). In instances in which a demand forecast is for more than one location, the demand forecast manager 1002 may distribute the override values to the locations within the indicated region or supply chain, as is further described below.

The reason code of a user override demand forecast may, in some embodiments, be a user-determined reason for which the user input a user override demand forecast. In some embodiments, the reason code may be one or more of a promotional forecast override (e.g., a user may have more information related an item promotion than a model does), a new item override or new store override (e.g., a model may not have sufficient information about a new item or location to generate an accurate demand forecast), a seasonal override (e.g., a model may not sufficiently account for a season or event), an inventory-based override (e.g., if a user knows that there will be an inventory shortage or surplus at a location), an item cancellation override (e.g., if an item is being discontinued), or a general override. The post-user override demand forecast data may, in some embodiments, indicate a user's preference regarding the forecasted demand of an item for a time period after the one or more time periods of the user override demand. For example, the post-user override demand data may indicate that a forecasted demand following the user override demand forecast be a model-based demand forecast, a user-defined number, or another value.

In the example shown, the demand forecast manager 1002 may determine whether to distribute the user override demand forecast (decision 1108). In some embodiments, the demand forecast manager 1002 may determine to distribute the user override demand forecast in response to detecting that the user override demand forecast is applicable to a plurality of locations (e.g., multiple locations, a region, or a supply chain). In some embodiments, the demand forecast manager 1002 may determine to distribute the user override demand forecast in response to detecting that the user override demand forecast includes data indicating that the override values are to be distributed. In response to determining to distribute the user override demand forecast, the demand forecast manager 1002 may proceed to do so (e.g., taking the “YES” branch to the step 1110). In response to determining not to distribute the user override demand forecast, the demand forecast manager 1002 may proceed to display the user override demand forecast (e.g., taking the “NO” branch to the step 1112).

In the example shown, the demand forecast manager 1002 may distribute the user override demand forecast (step 1110). In some embodiments, the demand forecast manager 1002 may distribute the override values to a plurality of locations. For example, for a user override demand forecast, if the override values are a predicted number of sold units of the item, and if the user override demand forecast is for a plurality of stores (e.g., a region or a supply chain), then the demand forecast manager 1002 may distribute the predicted number of sold units of the item across the plurality of stores, thereby generating a store-specific user override demand forecast for the item for each of the plurality of stores.

In some embodiments, the demand forecast manager 1002 may distribute the override values across a plurality of locations in proportion to each location's share of a model-based demand forecast. For example, a model may determine that, for 100 demanded units, a first store is responsible for the demand of 60 of the items whereas a second store is responsible for the demand of 40 of the items. Based on such data, the demand forecast manager 1002 may distribute override values of a user override demand forecast to both the locations with 60% of an override value going to the first store and 40% of an override value going to the second store. In some embodiments, however, the demand forecast manager 1002 may distribute the user override demand forecast in a different way, such as by distributing the demand equally among locations, by following a user-defined distribution plan, or by another method.

In the example shown, the demand forecast manager 1002 may display the user override demand forecast (step 1112). For example, the demand forecast manager 1002 may display, via the user interface, one or more aspects of the user override demand forecast, such as the one or more override values for the one or more time periods. In some embodiments, the demand forecast manager 1002 may display the user override demand forecast in the demand forecast display. In some embodiments, the demand forecast display may include, for an item over a period of time, a representation for each of the user override demand forecast and a model-based demand forecast. In some embodiments, the demand forecast manager 1002 may display aspects of the user override demand forecast using a component of a user interface other than the demand forecast display.

In the example shown, the demand forecast manager 1002 may select a demand forecast of a plurality of demand forecasts (step 1114). For example, the demand forecast manager 1002 may, in some instances, include a plurality of demand forecasts from which to select. In some instances, the demand forecast manager 1002 may have a plurality of demand forecasts for the same item, during the same one or more time periods, at the same one or more locations. For instance, the plurality of demand forecasts may include one or more model-based demand forecasts—such as channel-specific demand forecasts or an aggregated model-based demand forecast—a legacy demand forecast, a user override demand forecast, or another demand forecast. In some embodiments, the demand forecast manager 1002 may select a user override demand forecast if it is available (e.g., if the demand forecast manager 1002 has received a user override demand forecast for the relevant item, time period, and location). In some embodiments, the demand forecast manager 1002 may select one of a model-based demand forecast or a legacy demand forecast if no user override demand forecast is available. In some embodiments, the demand forecast manager 1002 may select one of the plurality of demand forecasts by using another method, such as combining one or more of the plurality of demand forecasts, receiving a user input from a supervisor or administrator selecting one of the plurality of demand forecasts, or by another method. In some embodiments, the demand forecast selected by the demand forecast manager 1002 may be the expected demand for the item, and it may be the demand forecast that is sent to downstream streams, as described below in connection with the step 1116. Example aspects of selecting a demand forecast are described above in connection with FIG. 7.

In the example shown, the demand forecast manager 1002 may send the selected demand forecast to a downstream system (step 1116). If, for example, the demand forecast manager 1002 selected the user override demand forecast, then the demand forecast manager 1002 may send the user override demand forecast to the downstream system. In some embodiments, the downstream system may include the user interfaces described above in connection with the demand forecast manager 1002. In some embodiments, the downstream system may be one of the demand forecast consumers 220, which are described above in connection with FIG. 2. In some embodiments, the downstream system may perform one or more functions related to a retail enterprise, such as managing inventory positioning or ordering, transportation planning, sourcing, or another function of a retail enterprise that may use forecasted demand data.

In the example shown, the demand forecast manager 1002 may determine a post-user override demand forecast (step 1118). The post-user override demand forecast may include one or more demand forecast values for one or more time periods that are later than the one or more time periods of the user override demand forecast. In some embodiments, the post-user override demand forecast may be selected as an expected demand for the time period after the user override demand forecast and be sent to a downstream system for one or more time periods after the user override demand forecast. In some embodiments, the demand forecast manager 1002 may use a demand forecast from another system as the post-user override demand forecast value (e.g., using one or more demand forecasts received at the step 1102). For example, the demand forecast manager 1002 may use one or more model-based demand forecasts (e.g., from the GAM models 204) as the post-user override demand forecast. In some embodiments, the post-user override demand forecast may be determined based on a user input defining a demand forecast.

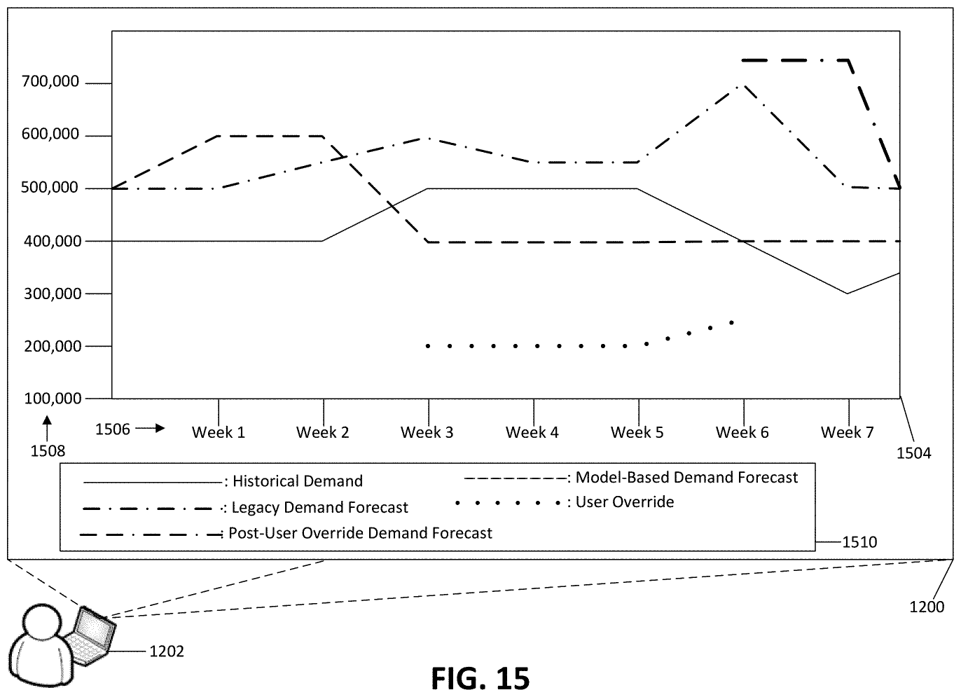

In some embodiments, the demand forecast manager 1002 may apply rules for determining the post-user override demand forecast. For example, the demand forecast manager 1002 may determine the post-user override demand forecast based on characteristics of one or more of the user override demand forecast or a model-based demand forecast. For example, the post-user override demand forecast may depend on characteristics of the item, including the item's price, category or department, degree to which the item is, or is not, interchangeable with other items, or another item characteristic. As an example, a user override demand forecast may set override values at a lower value than a model-based demand forecast, because a user may be aware, for example, of an inventory shortage or another circumstance that may affect how many items are at a location. Due to a characteristic of the item (e.g., a low degree of interchangeability), the demand forecast manager 1002 may determine that demand for the item will accumulate during the user override period. As a result, the demand forecast manager 1002 may set values for the post-user override demand forecast as higher than a model-based forecast value may otherwise suggest, thereby accommodating a larger, built-up demand caused by a period of low inventory. In some embodiments, the demand forecast manager 1002 may display a post-user override demand forecast in a user interface, as depicted in the example of FIG. 15.

FIGS. 12-18 illustrate a plurality of user interfaces and a user 1202. In some embodiments, the demand forecast manager 1002 may generate and/or display the user interfaces illustrated in the FIGS. 12-18. In some embodiments, the demand forecast manager 1002 may use one or more of the computing device 216 or the demand forecast consumers 220 to display the user interfaces of FIGS. 12-18. In some embodiments, the demand forecast manager 1002 may cause one or more the computing device 216 or the demand forecast consumers 220 to display the user interfaces described in connection with FIGS. 12-18. In some embodiments, the user 1202 may be a worker of a retail organization. In some embodiments, the user 1202 may interact with one or more of the user interfaces of the FIGS. 12-18, for example via a computing device associated with the user. For example, the user 1202 may input a user override demand forecast, select one or more items, or perform other operations in connection with forecasting item demand.

FIG. 12 illustrates a user interface 1200. The user interface 1200 includes a demand forecast display 1204. The demand forecast display 1204 may include one or more demand forecasts for one or more items at one or more locations. In some embodiments, the demand forecast display 1204 may aggregate demand forecasts for a plurality of items (e.g., for a class or category of items) and display an aggregated demand forecast. In other embodiments, demand forecasts for items may be displayed separately on the demand forecast display 1204 (e.g., one or more demand forecasts for Brand X Baby Wipes and one or more other demand forecasts for Brand Y Baby Wipes may be displayed, rather than aggregating to display a more general Baby Wipes demand forecast). In some embodiments, the demand forecast display 1204 may aggregate demand forecasts for a plurality of locations and display the aggregated demand forecast. In other embodiments, the demand forecast display 1204 may separately display demand forecasts by location (e.g., one or more demand forecast for Brand X Baby Wipes at Location A, one or more demand forecasts for Brand X Baby Wipes at Location B, and, optionally, an aggregated Baby X Baby Wipes for multiple locations). In the example of FIG. 12, the current week may, for example, be Week 1. However, in some embodiments, the current week may, for example, be Week 2, Week 3, or another week, thereby displaying to the user 1202 past demand forecasts.

In the example of FIG. 12, the demand forecast display 1204 includes one or more time periods 1206 as the x-axis and the demand values 1208 as the y-axis. The demand values 1208 may be a number of units of an item (e.g., a forecasted demand for an item). As illustrated by the key 1210, the demand forecast display 1204 includes a model-based demand forecast (as represented by a dashed line), a legacy demand forecast (as represented by a dashed-and-dotted line), and a user override demand forecast (as represented by a dotted line). Furthermore, the demand forecast display 1204 includes historical demand for the item (as represented by the solid line).

In some embodiments, the model-based demand forecast may be from one or more GAM models 204. In some embodiments, the demand forecast display 1204 may display channel-specific demand forecasts that make up the model-based demand forecast (e.g., one or more of a localized demand forecast, a walk-in demand forecast, and a ship-to-home demand forecast). In some embodiments, the legacy demand forecast may be from a second forecasting system, such as the legacy forecasting system 205. In the example shown, the user 1202 may have input the user override demand forecast for the Weeks 4-6. In the example shown, the user override demand forecast has a plurality of override values for a plurality of time periods, starting at Week 3 and ending at the Week 6. For each time period, there is a corresponding override value (e.g., for Week 3, the override value is 450,00; for Week 6, the override value is 500,000). In some embodiments, the historical demand may represent historical sales of the item. For example, the historical demand may be average sales for the item over the last three years for the illustrated time periods.

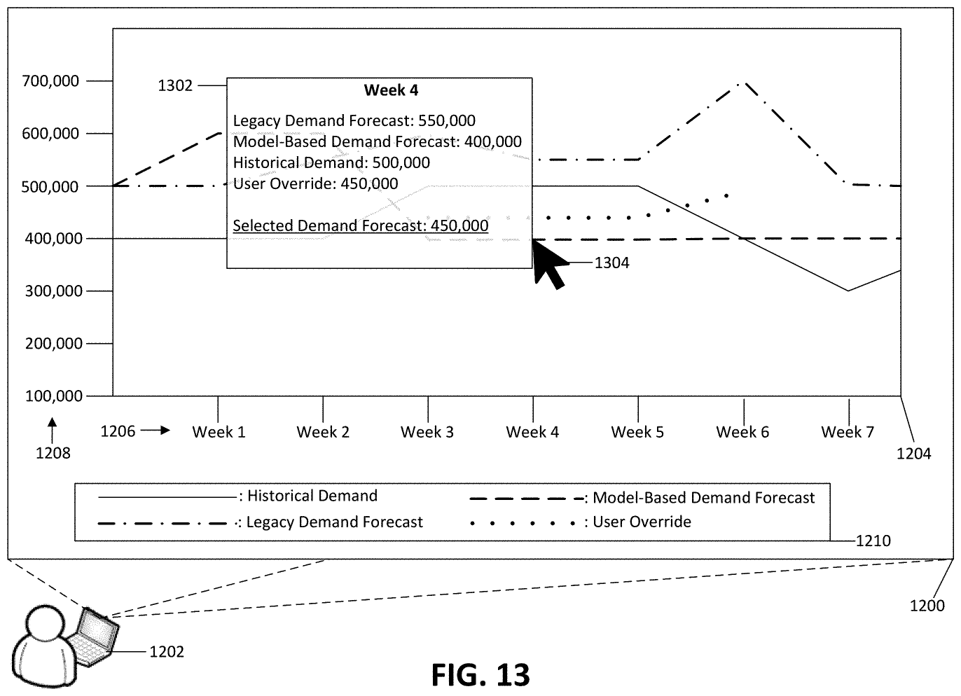

FIG. 13 further illustrates the user interface 1200. As shown in the example of FIG. 13, the user 1202 may interact with the demand forecast display 1204 by using a selector 1304. The selector 1304 may be an arrow of a mouse or touch pad that is used by the user 1202, the selector 1304 may be a touch via a touch screen, or the selector 1304 may be another mechanism for interacting with the user interface 1200. In the example shown, the demand forecast display 1204 may display demand forecast data 1302 in response to a selection (e.g., a click on, or a hover over, an aspect of the demand forecast display 1204). The demand forecast data 1302 may include one or more demand forecast values for an item that are displayed by the demand forecast display 1204 (e.g., a model-based demand forecast, a legacy demand forecast, a user override demand forecast). Furthermore, the demand forecast values may be for a time period selected by a user (e.g., Week 4). As illustrated in the example of FIG. 13, the demand forecast data 1302 may further include a value for the historical demand. Furthermore, the demand forecast data 1302 may display a selected demand forecast value. As described above, the demand forecast manager 1002 may, in some embodiments, select a demand forecast from a plurality of demand forecasts (e.g., to send to a downstream system), an operation that is described in connection with the step 1114 of FIG. 11. In the example shown, the selected demand forecast for Week 4 is the user override demand forecast, which has a demand forecast override value of 450,000 units for Week 4.

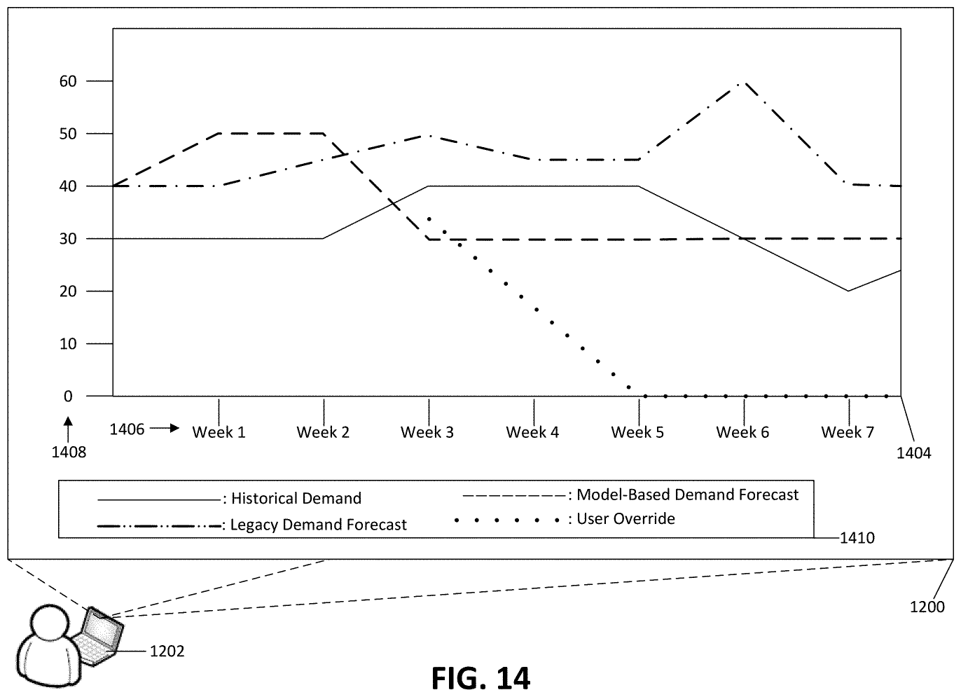

FIG. 14 further illustrates the user interface 1200. In the example of FIG. 14, the user interface 1200 includes the demand forecast display 1404, which includes one or more demand forecasts for an item having one or more demand forecast values 1408 corresponding to one or more time periods 1406. Each of the demand forecasts is represented by a line according to the key 1410. As illustrated in the demand forecast display 1404, the user override demand forecast includes the override value 35 for the Week 3. For the Weeks 5-7, the user override demand forecast values are 0. In some embodiments, the demand forecast manager 1002 may select the user override demand forecast value of 0 for the weeks 5-7 to send to a downstream system, even though the other demand forecasts, including the model-based demand forecast values are non-zero values. Thus, as illustrated by the example of FIG. 14, a user may use the override feature of the present disclosure as part of the process for discontinuing an item. In some embodiments, the user may set an override value (e.g., zero) for a period of time that extends indefinitely, until the user override demand forecast is canceled or overridden by another user override demand forecast.

FIG. 15 further illustrates the user interface 1200. In the example of FIG. 15, the user interface 1500 includes the demand forecast display 1504, which includes one or more demand forecasts for an item having one or more demand forecast values 1508 corresponding to one or more time periods 1506. Each of the demand forecasts is represented by a line according to the key 1510. The demand forecast display 1504 includes a post-user override demand forecast (as represented by the dashed-dotted-dashed line). As described above in connection with the step 1118 of FIG. 11, the demand forecast manager 1002 may, in some embodiments, determine a post-user override demand forecast for one or more time periods after the user override demand forecast, as illustrated by the post-user override demand forecast of FIG. 15, which begins at Week 6. The post-user override demand forecast may have been defined by the user 1202, determined by the demand forecast manager 1002 based on one or more of a model-based demand forecast, legacy demand forecast, a previous user override demand forecast, one or more item characteristics, one or more location characteristics, or by another consideration. In the example of FIG. 15, the demand forecast manager 1002 may have determined that, because the user override demand forecast values were lower than other demand forecasts, the post-user override demand forecast values are relatively higher to accommodate demand that was not met during the time periods of the user override.

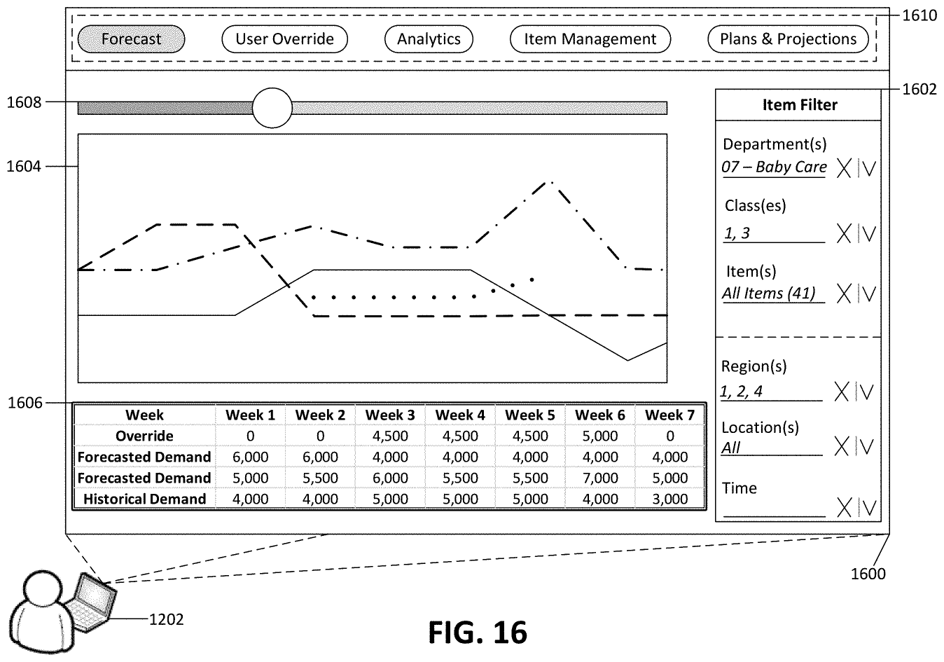

FIG. 16 illustrates a user interface 1600. The user interface 1600 includes an item filter field 1602, a first demand forecast display 1604, a second demand forecast display 1606, a time filter 1608, and a plurality of options 1610. The item filter field 1602 may include one or more input fields (e.g., fields for inputting text or fields that, when selected, provide a list of options from which to select) for configuring the demand forecast displays 1604-1606. For example, the demand forecast displays 1604-1606 may display the one or more items, across the one or more locations, for the one or more time periods selected via the item filter field 1602. In the example shown, the item filter field 1602 includes three input fields for selecting the one or more items to display: an input field for selecting one or more departments (e.g., Baby Care); an input field for selecting a class within the one or more departments; and an input field for selecting one or more items within the one or more classes (e.g., All Items, which is 41 total items in the example shown). Thus, in the example of FIG. 16, the demand forecast manager 1002 may cause the demand forecast displays 1604-1604 to display one or more aggregated demand forecasts for 41 items of the classes 1 and 3 in the Baby Care Department of a retail enterprise. Furthermore, the item filter field 1602 includes a plurality of input fields for selecting a location (e.g., a region input field and a location input field), and the item filter field 1602 includes an input field for selecting one or more time periods to display.

As illustrated in the example of FIG. 16, the user interface 1600 may include a plurality of demand forecast displays, such as the chart of the demand forecast display 1604 and the table of the demand forecast display 1606. In some embodiments, each of the demand forecast displays 1604-1606 may include the same one or more demand forecasts for the same item. In some embodiments, however, the demand forecast manager 1002 may display different demand forecasts for different items for the demand forecast displays 1604-1606. In some embodiments, the time filter 1608 includes a moveable component that a user may manipulate (e.g., slide across a time-indexed track) to determine a time period to display. In some embodiments, a user may use the time filter 1608 instead of, or in addition to, a time-related input field of the item filter field 1602.

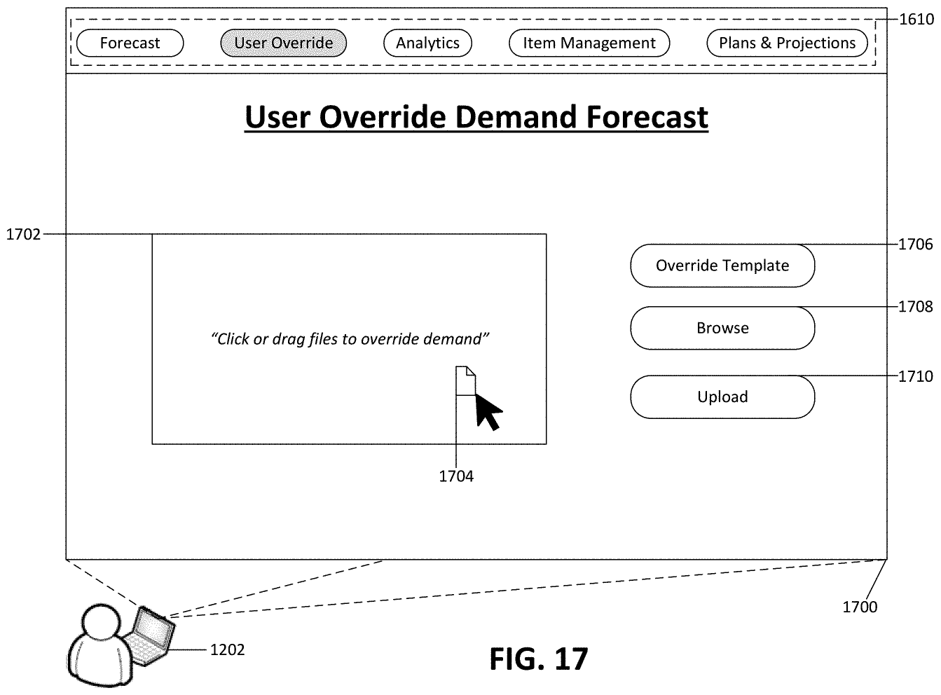

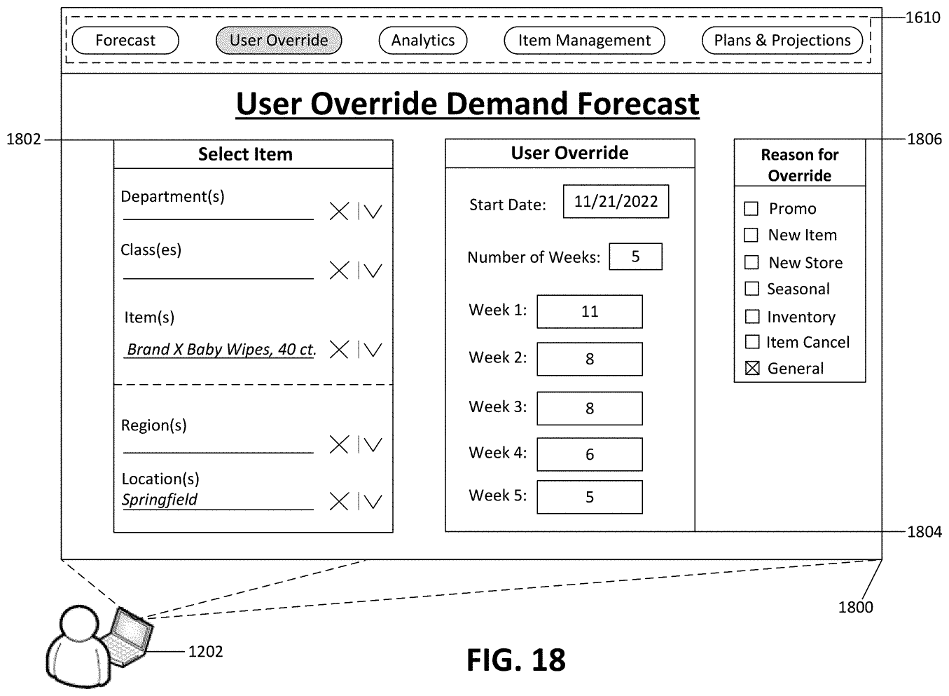

The options 1610 may include a plurality of selectable fields (e.g., buttons) that correspond to functions offered by the demand forecast manager 1002 or by a system with which the demand forecast system 1002 is communicatively coupled. For example, a “Forecast” field may be currently selected in the example of FIG. 16, thereby indicating that demand forecast data is currently being shown via the user interface 1600. In response to receiving a selection of the “User Override” field, the demand forecast manager 1002 may determine that the user has requested to input a user override demand forecast, and the demand forecast manager 1002 may thus display an input field or user interface for a user to input a user override demand forecast, as illustrated below in connection with the FIGS. 17-18. Notably, the specific manner in which demand forecasts are determined following the time periods during which an override may apply might be manually controlled by the user via a user interface, or may be automatically adjusted based on the specific item characteristics or expected item demand associated with the item to which the override is applied. As such, the various override periods, and user interface examples described above, may each be used, for example on a per-item, per-location, chainwide, or other granularity/segmentation basis.

In response to receiving a selection of the “Analytics” field, the demand forecast manager 1002 may direct the user to an analytics system or user interface, which may, among other things, display data that includes one or more of user override demand forecast data, model-based demand forecast data, legacy forecast data, historical demand data, actual item sales data, or other data that may be relevant to an analyst or business unit evaluating one or more aspects of the present disclosure. In some embodiments, aspects of the present disclosure may preserve model-based demand forecast data even if a user inputs user override demand forecast data, and both model-based demand forecast data and user override demand forecast data may be sent to an analytics system. As a result, an analytics system may, in some embodiments, provide a comparison between performance of a model-based demand forecast system with user-defined demand forecasts, thereby allowing an enterprise to identify situations in which models may perform better than workers and vice-versa, an improvement that may further increase the accuracy of demand forecasting. In response to a selection of the “Item Management” or “Plans & Projections” fields, the demand forecast manager 1002 may direct the user to one or more systems, such as the demand forecast consumers 220, which may include, for example, transportation planning systems, inventory ordering or management systems, or other systems that may use demand forecast data.

FIG. 17 illustrates a user interface 1700. The user interface 1700 includes a plurality of components for a user to input a user override demand forecast. For example, the user interface 1700 includes a user override demand forecast input field 1702 for receiving user override data 1704. The user override data 1704 may be a data file (e.g., a CSV file or an xlsx file) that includes data for one or more user override demand forecasts, such as an item, override values, and time periods. As shown, a user may drag and drop a data file including the user override data 1704 into the user override demand forecast input field 1702. Example user override data is illustrated and described in connection with FIG. 19. The user interface 1700 further includes a plurality of fields 1706-1710 for interacting with the user interface 1700. For example, in response to a selection of the view override template button 1706, the demand forecast manager 1002 may display, or cause a download of, a template for the user override data 1704. Such a template may include, for example, expected fields, expected data formats, an expected file type, or other characteristics of the user override data 1704 so that the demand forecast manager 1002 may ingest the user override data 1704. In some embodiments, a user may use the browse button 1708 to search for the user override data 1704, and a user may use the upload button 1710 to submit the user override data 1704 to the demand forecast manager 1002.

FIG. 18 illustrates a user interface 1800. The user interface 1800 includes a plurality of components for a user to input a user override demand forecast. In some embodiments, the demand forecast manager 1002 may display the user interface 1800 instead of, or in addition to, the user interface 1700 for a user to input a user override demand forecast. The user interface 1800 includes an item filter field 1802, a plurality of override value fields 1804, and a reason code field 1806. The item filter field 1802 includes a plurality of input fields for selecting one or more items for which to input an override demand. In some embodiments, the item filter field 1802 includes at least some fields that are the same as the input fields of the item filter field 1602 of FIG. 16. In some embodiments, the item filter field 1802 may auto-populate based on the one or more items displayed in a demand forecast display.

In the example shown, the override value fields 1804 include a field for inputting a start date of a user override demand forecast, a field for inputting a duration of a user override demand forecast, and a plurality of fields for inputting override values corresponding to the plurality of time periods of the user override demand forecast. In the example shown, the reason code field 1806 includes a list of selectable check boxes corresponding to reasons for which the user is inputting a user override demand forecast. In the example shown, the reason code field 1806 includes reasons corresponding to a promotion, new item, new store, seasonal, inventory, item cancel, and general. In some embodiments, the user may submit the data input via the fields of the user interface 1800 and, in some embodiments, such data may be appropriately formatted so that it may be ingested by the demand forecast manager 1002.

FIG. 19 illustrates example user override data 1900. For example, the user override data 1900 may be the user override data 1304 of FIG. 13 or it may be a formatted version of data input via the input fields of the FIG. 18. In some embodiments, the user override data 1900 may be formatted as a structed data file with a plurality of fields, one or more of which may have one or more data values. In the example shown, the user override data 1900 includes two user override demand forecasts, each of which identify an item by an ID number. As illustrated, however, the user override data 1900 may include more than two user override demand forecasts, thereby allowing a user to batch user override demand forecasts and send them at one time to the demand forecast manager 1002.

In the example shown, each of the user override demand forecasts include a location (e.g., a particular location or a plurality of locations of a region) to which the user override demand forecast applies. In the example shown, each of the user override demand forecasts include a start date for the user override to apply and a number of weeks that the user override applies. In some embodiments, however, a different period of time (e.g., days or months) may be used instead of weeks. In the example shown, each of the user override demand forecasts includes one or more override values corresponding to the time periods. In some embodiments, the user override data 1900 may be sent directly to the demand forecast manager 1002, which may, in some embodiments, send the user override data to the user override demand forecast database 1010. In some embodiments, the user override data may be first sent to the user override demand forecast database 1010 and then retrieved by the demand forecast manager 1002.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. A system for forecasting demand of an item, the system comprising:
at least one processor and at least one memory device, the memory device storing instructions that, when executed by the at least one processor, cause the system to:
receive a model-based demand forecast for an item from a demand forecasting system;
display a user interface, the user interface comprising a demand forecast display including the model-based demand forecast for the item;
display in the user interface one or more input fields for overriding the model-based demand forecast;
receive, via the one or more input fields for overriding the model-based demand forecast, a user override demand forecast including the item and one or more override values for one or more time periods; and
display, in the demand forecast display, the one or more override values for the one or more time periods.

2. The system of claim 1,
wherein the model-based demand forecast includes a model-based predicted demand for the item at a retail store during each of the one or more time periods; and
wherein each of the one or more override values is a user-defined predicted demand for the item at the retail store during a corresponding time period of the one or more time periods.

3. The system of claim 1, wherein the instructions, when executed by the at least one processor, further cause the system to:
select the user override demand forecast from a plurality of demand forecasts as a selected demand forecast; and
send the selected demand forecast to one or more of a system for managing inventory or a system for facilitating item transportation.

4. The system of claims 1, wherein displaying the one or more input fields for overriding the model-based demand forecast is automatically performed in response to receiving, via the user interface, a request to override the model-based demand forecast.

5. The system of claim 1, wherein the instructions, when executed by the processor, further cause the system to determine a post-user override demand forecast for the item, the post-user override demand forecast including one or more post-user override demand forecast values corresponding to one or more post-user override time periods, each of the post-user override time periods being later than each of one or more time periods of the user override demand forecast.

6. The system of claim 5, wherein determining the post-user override demand forecast for the item includes performing one or more of:
receiving a second user override demand forecast for the item;
selecting the model-based demand forecast of the item; or
determining the post-user override demand values based at least in part on the override values of the user override demand forecast, on a characteristic of the item, and on the model-based demand forecast of the item.

7. The system of claim 1,
wherein the user interface further comprises an item filter field including input fields for selecting a time period, an item, and a location;
wherein the instructions, when executed by the processor, further cause the system to receive, via the item filter field, a selection of the item; and
wherein generating the demand forecast display including the model-based demand forecast of the item is automatically performed in response to receiving the selection of the item via the item filter field.

8. The system of claim 1,
wherein the model-based demand forecast comprises a plurality of channel-specific demand forecasts;
wherein the demand forecast display includes each of the plurality of channel-specific demand forecasts.

9. The system of claim 1,
wherein the demand forecast display is a line chart; and
wherein each of the model-based demand forecast and the user override demand forecast is represented as a line in the line chart.

10. The system of claim 1,
wherein the instructions, when executed by the processor, further cause the system to, in response to determining that the user override demand forecast is for a plurality of locations, distribute the user override demand forecast to the plurality of locations; and
wherein distributing the user override demand forecast to the plurality of locations is performed at least in part based on data received from the demand forecasting system.

11. The system of claim 1, wherein the demand forecast display further includes historical sales data of the item.

12. The system of claim 1,
wherein the instructions, when executed by the processor, further cause the system to receive a legacy demand forecast for the item from a legacy demand forecasting system; and
wherein the demand forecast display further includes the legacy demand forecast.

13. The system of claim 1, wherein each of the override values is a quantity of units of the item.

14. The system of claim 1, wherein displaying the one or more input fields for overriding the model-based demand forecast comprises displaying a second user interface comprising the one or more input fields for overriding the model-based demand forecast.

15. A method for forecasting demand for an item, the method comprising:
receiving a model-based demand forecast for an item from a demand forecasting system;
displaying a user interface, the user interface comprising a demand forecast display including the model-based demand forecast for the item;
displaying one or more input fields for overriding the model-based demand forecast;
receiving, via the one or more input fields for overriding the model-based demand forecast, a user override demand forecast including the item and one or more override values for one or more time periods; and
displaying, in the demand forecast display, the one or more override values for the one or more time periods.

16. The method of claim 15,
wherein the model-based demand forecast includes a model-based predicted demand for the item at a retail store during each of the one or more time periods; and
wherein each of the one or more override values is a user-defined predicted demand for the item at the retail store during a corresponding time period of the one or more time periods.

17. The method of claim 15, further comprising displaying demand forecast data in response to a user selection, in the demand forecast display, of one of the one or more time periods.

18. The method of claim 15, further comprising sending the model-based demand forecast and the user override demand forecast to an analytics system.

19. The method of claim 15, wherein receiving, via the one or more input fields for overriding the model-based demand forecast, the user override demand forecast comprises receiving a structured data file including user override data.

20. A non-transitory computer-readable medium, having stored instructions thereon, which when executed by a processor, cause the processor to forecast demand by performing a method comprising:
receiving a model-based demand forecast for an item at a location from a demand forecasting system;
generating a user interface, the user interface comprising a demand forecast display including the model-based demand forecast for the item;
generating, for display in the user interface, one or more input fields for overriding the model-based demand forecast;
receiving, via the one or more input fields for overriding the model-based demand forecast, a user override demand forecast including the item and one or more override values at the location for one or more time periods; and
generating, for display in the demand forecast display, the one or more override values for the one or more time periods.
